(19) United States
(12) Patent Application Publication
(10) Pub. No.: US 2002/0003547 A1
(43) Pub. Date: Jan. 10, 2002

(54) System and method for transcoding information for an audio or limited display user interface

(76) Inventors: Zhi Wang, Los Angeles, CA (US); Jian Zhang, Los Angeles, CA (US)

Correspondence Address: Squire, Sanders & Dempsey L.L.P., Two Renaissance Square, Suite 2700, 40 N. Central Avenue, Phoenix, AZ, 85004-4498, US

(21) Appl. No.: 09/797,522

(22) Filed: Feb. 28, 2001

Related U.S. Application Data
(62) Division of application No. 09/706,898, filed on Nov. 6, 2000.
Application No. 09/706,898 is a continuation-in-part of application No. 09/574,990, filed on May 19, 2000.

(51) Int. Cl. G06F 13/00

(52) U.S. Cl. 345/727; 345/744

(57) ABSTRACT

A system for voice browsing or transcoding permits access and navigation to information via an audio user interface or a limited display user interface. The audio user interface permits speech or telephone keypad input to interrupt the presentation of information, for example, to direct following a hypertext link. When operating with the Internet, the user of one or more access devices including a cell phone, telephone, portable computer, or workstation may request a web page by providing an address. Guidance may be prepared ahead of time by the user operating an editor. Guidance may direct summarization, selection, annotation, and restatement of the requested content. Guidance may include statements of a markup language that include a structural summary description of the content or a hidden Markov model. To allow for frequent changes in the arrangement of content on web pages provided by the Internet, portions of the content are identified for the application of particular guidance by aligning a structural summary description of the current content to the structural summary description stored with the guidance. Guidance suitable for particular content may be located on the basis of an address of the content (e.g., a URL), of a related address, or of being within the scope of a regular expression. Guidance produces derivative content which may be easier to understand when presented in audio or easier to understand when presented on a display of limited area or resolution. Derivative content may include a set of web pages hierarchically organized with connecting links. The complexity and importance of regions of the requested web page are assessed in developing the hierarchy and organization of the set of web pages to be presented. Each web page may then be expressed in a voice mark up language and presented through a speech engine to the user. Information from the requested web page may be presented on the same or a different access device.

This application is a continuation-in-part application of, and claims priority from, U.S. patent application Ser. No. 09/574,990 by Wang, et al., filed May 19, 2000, incorporated herein by this reference.

### BACKGROUND OF THE INVENTION

The present invention relates to a communication system that transcodes information prepared for a large visual display into information to be used with a small visual display or to be used in an audio format, for example, as on a telephone.

Via the World-Wide-Web or the Internet, a user has access to a vast variety of information including, for example, weather forecasting, traffic reports, movie listings, news articles, and stock prices. A desk-top personal computer with a conventional desk-top browsing program may communicate with the Internet, be directed to search for information (typically apportioned into so-called pages), display listed search results, permit selection from the list, and display text, pictures, multimedia presentations (audio, animations, movies), and links to other pages. A typical page is prepared by intermixing with the information to be displayed, various symbols of a markup language that direct, among other things, the relative sizes of items to display, color, and relative position and of the information. The markup language is read by the browsing program so that the presentation better utilizes the particular display of the personal computer, for example by wrapping large amounts of text within suitable margins.

Recently, portable devices have been introduced that have the ability to communicate via the Internet, operate like a telephone, and provide a relatively small display area and relatively small keyboard. Although these devices may have a browse process analogous to the desk-top browsing process discussed above, without the present invention, there is no convenient way to accomplish presentation of information received from the Internet because such information was not designed to be presented on a small display or in audio. For example, if the information is to be presented entirely in audio, simply reciting the words from left to right as they might appear on a desk-top personal computer display is likely to become tedious to listen to and confusing to the listener. Further, there is no convenient way for the user to make selections, to input requested data into a form, and to follow hypertext references to other pages (herein called links). It is desirable to perform these functions from a common telephone, i.e., a device having only audio input and output capability.

Text and screen readers are known, and such readers have been used to provide auditory presentations of textual information through speech synthesis. However, because the content received from the Internet is received as a mixture of text and markup language symbols, reciting the content received would be unintelligible to the average user who is unfamiliar with markup language symbols. Because the markup symbols define the visual arrangement of text on a monitor screen, simply omitting the markup symbols destroys relationships among the elements of information, thereby confusing an audio presentation of the information.

Although the Internet is primarily designed for visual-based access and navigation (e.g., searching and following links), there is a growing interest in access to information organized for presentation in either an auditory or a primarily auditory with visual format. For example, users may include the visually impaired and individuals who, by preference, timing, location, or proximity to equipment, desire to access the Internet over a common telephone. Thus, it is desirable to facilitate a more understandable and controllable experience for individuals who access the content of the Internet through equipment adapted for either an auditory or a primarily auditory with visual format.

### SUMMARY OF THE INVENTION

A system for voice browsing or transcoding permits access and navigation to information via an audio user interface or a limited display user interface. The audio user interface permits speech or telephone keypad input to interrupt the presentation of information, for example, to direct following a hypertext link. When operating with the Internet, the user of one or more access devices including a cell phone, telephone, portable computer, or workstation may request a web page by providing an address. Guidance may be prepared ahead of time by the user operating an editor. Guidance may direct summarization, selection, annotation, and restatement of the requested content. Guidance may include statements of a markup language that include a structural summary description of the content or a hidden Markov model. To allow for frequent changes in the arrangement of content on web pages provided by the Internet, portions of the content are identified for the application of particular guidance by aligning a structural summary description of the current content to the structural summary description stored with the guidance. Guidance suitable for particular content may be located on the basis of an address of the content (e.g., a URL), of a related address, or of being within the scope of a regular expression. Guidance produces derivative content which may be easier to understand when presented in audio or easier to understand when presented on a display of limited area or resolution. Derivative content may include a set of web pages hierarchically organized with connecting links. The complexity and importance of regions of the requested web page are assessed in developing the hierarchy and organization of the set of web pages to be presented. Each web page may then be expressed in a voice mark up language and presented through a speech engine to the user. Information from the requested web page may be presented on the same or a different access device.

A presentation by a first user interface may include a link for transferring control to a second user interface. For example, the user of a limited display device that includes a telephone (e.g., a so-called web phone) may follow a link on the limited display for terminating the current session of a limited display user interface, placing a telephone call, and establishing a session with an audio user interface.

### BRIEF DESCRIPTION OF THE DRAWING

Embodiments of the present invention will now be further described with reference to the drawing, wherein like designations denote like elements, and wherein:

FIG. 1 is a functional block diagram of a system according to various aspects of the present invention;

FIG. 2 is a message sequence diagram in an exemplary implementation for providing an audio user interface in the system of FIG. 1;

FIG. 3 is a flow diagram for a method for supporting various user interface functions of the system of FIG. 1;

FIG. 4 is a data flow diagram of a process for preparing derivative content from primary content and guidance according to various aspects of the present invention;

FIG. 5A is a flow diagram for a method for finding guidance performed in the process of FIG. 4;

FIG. 5B is a flow diagram for a method for reducing the complexity of content to be presented as performed in the process of FIG. 4;

FIG. 6 is a flow diagram for presenting derivative content in the method of FIG. 3;

FIG. 7 is a message sequence diagram in an exemplary implementation for supporting a limited display device in the system of FIG. 1;

FIG. 8 is a message sequence diagram in an exemplary implementation for providing a guidance editor in the system of FIG. 1;

FIG. 9 is a screen layout for a graphical user interface for editing guidance according to FIG. 8;

FIG. 10A is a portion of the screen layout of FIG. 9 after a revision to guidance has been directed;

FIG. 10B is a schematic presentation of derived content on a limited display device; and

FIG. 11 is a message sequence diagram in an exemplary implementation of a method for supporting a device having both an audio device and a limited display device.

### DETAILED DESCRIPTION OF PREFERRED EMBODIMENTS

The present invention provides, inter alia, a system for accessing and presenting information. The information may be accessed via a computer network (e.g., a local area network, an intranet, or the Internet). Information may be accessed using a common telephone or a computer workstation. In addition to receiving an audio presentation of information, the user may request other information (e.g., navigate the Internet) by responding to words spoken by one or more voices (e.g., such as a female voice and a male voice). To request information, the user may repeat a word, actuate a button on the telephone, or speak a command. The response may specify a link to follow or specify information to provide to a process or server on the network.

A system according to various aspects of the present invention may include processes for transcoding, voice browsing, and text-to-speech software for reciting information in audio for the user to listen to. Transcoding is generally a process that acts upon information expressed in a markup language (e.g., Hypertext Markup Language (HTML), Extensible Markup Language (XML), and adaptations of these for voice and wireless systems such as Wireless Markup Language (WML) and Voice Extensible Markup Language (VoiceXML)). For example, a result of transcoding may be input to a text-to-speech process to be recited in audio. Voice browsing may respond to any of various inputs from the user including the user's spoken words and key actuation on a keyboard or telephone dialing keypad. Browsing generally includes following a link to a desired page.

In operation a system according to various aspects of the present invention may provide a user with: (a) access to information such as news headlines, financial information, weather information, etc., in a manner that is personalized and substantively controlled by the user; and (b) a substantially “audible only” version of such information. Such a system permits the user to retrieve customized news and other information. Further, access is provided to user-requested information (e.g., web pages) that have not been edited by the user. For example, information received from the Internet (e.g., web pages in HTML) may be transcoded by application of guidance to provide selected information in VoiceXML for recitation to the user via a speaker or telephone.

A service operative in conjunction with the Internet and provided according to various aspects of the present invention may provide, inter alia, a personal page for each customer and a transcoding service to transcode a conventional visual-friendly HTML web page to an aurally-friendly set of pages. Each customer may specify a personal page to include, for example, status of e-mail, a calendar, a news report, a sports report, a weather report, a traffic report, and movie listings.

Any information in a hypertext or markup language (e.g., an Internet web page) may be transcoded according to various aspects of the present invention. Transcoding may include applying directives supplied in a file herein called guidance. Guidance may be created by the user for each web page of interest, thereby facilitating listening preferences. Guidance may specify the manner in which the web page is rendered (e.g., visually and/or in audio), for example, by specifying features such as volume, rate, pitch, direction, suppressing output for specific elements, spelling out particular text letter by letter, speech fonts (male/female, adult/child, etc.), inserted text before and after an element of content, sound effects before, during, and after elements of content, and adding music or prerecorded sounds.

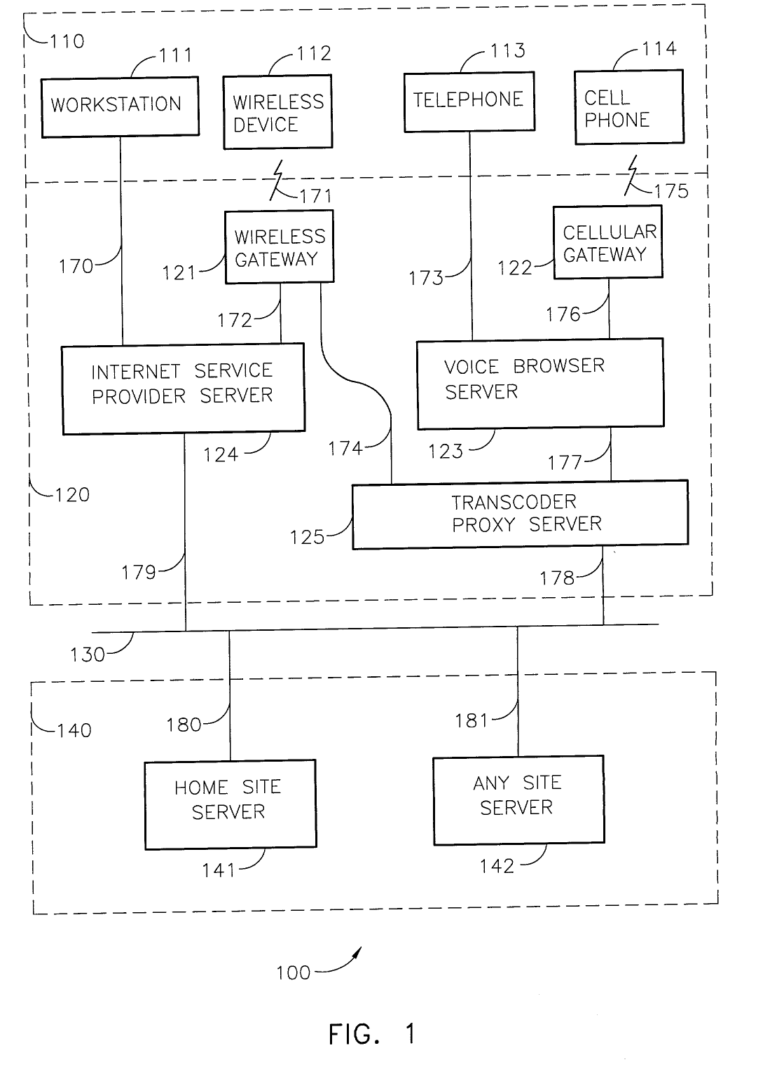

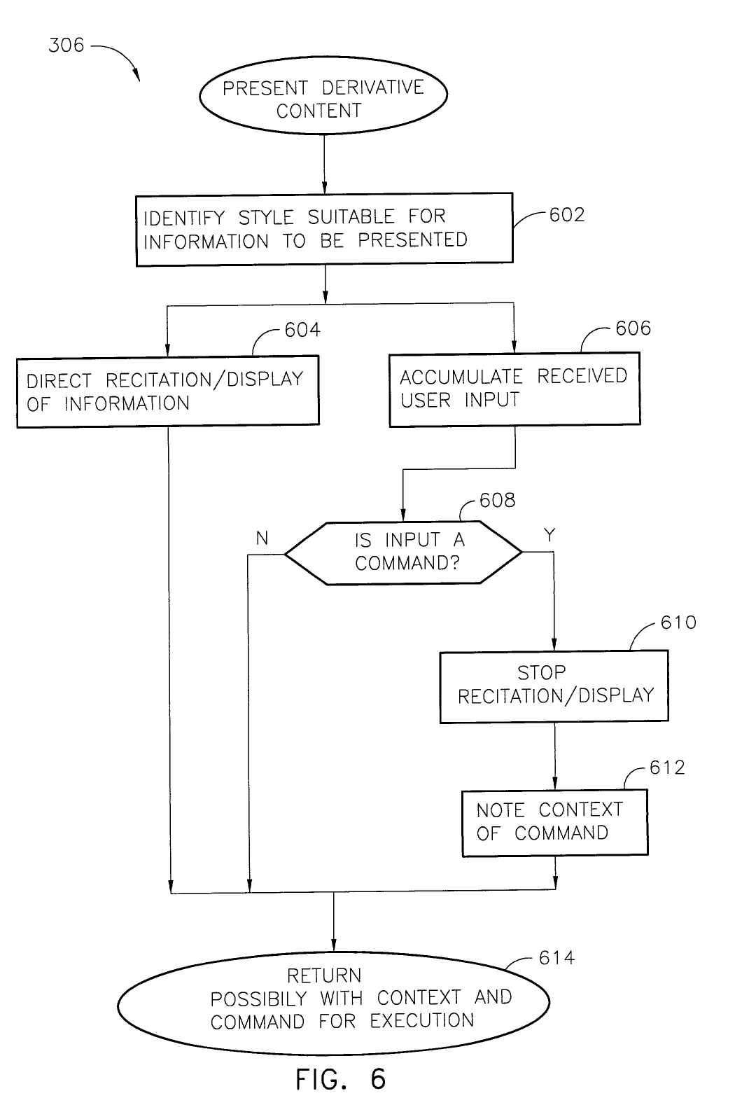

A communication system, according to various aspects of the present invention, includes any plurality of computers (e.g., servers, workstations, and portable devices including telephones, and portable computers) coupled to a network for the exchange of information to any of the computers as a visual presentation and/or to any of the computers as an audio presentation. The system may provide, inter alia, a graphical user interface (GUI), an audio user interface, and a limited display user interface. For example, system 100 of FIGS. 1-12 includes access devices 110, gateway devices 120, a network 130, and network servers 140. Access devices 110 are coupled from time to time to gateways 120 via any conventional physical and logical protocols. Gateways 120 and network servers 140 are coupled from time to time (or by dedicated links) to network 130 via any conventional networking technology including physical and logical protocols that may differ from the physical and logical protocols discussed above with reference to access devices 110. These protocols permit information to be transferred effectively simultaneously between any one or more gateways and servers. Each functional block shown in FIG. 1 is representative of any number of like functional blocks that may operate independently (e.g., cell phones operated by independent users), operate in tandem (e.g., numerous transcoder gateways cooperating from common input and output queues), or operate at different geographical locations or for different special purposes (e.g., wireless gateways for different protocols or home site servers at different corporate headquarters).

Access devices include any device that facilitates access to information that is stored on a server coupled to a network. Access devices 110, for example, comprise an unrelated set of a wide variety of equipment operated independently by many users. Representative devices include workstation 111 (e.g., a desk-top computer), wireless device 112 (e.g., a laptop, palm-top, or network appliance), telephone 113, and cell phone 114 (e.g., any wireless telephone or pager). Links shown between functional blocks represent any communication capability including for example, radio, infrared, and wired networks including cable TV, local area networks, the public switched telephone network, and proprietary dedicated lines.

Workstation 111 may be coupled to network 130 through Internet service provider (ISP) gateway 124 by links 170 and 179. Wireless device 112 may be coupled to network 130 via a wireless link 171 to wireless gateway 121, link 172 to ISP gateway 124, and link 179. Wireless device 112 may alternatively be coupled to network 130 via wireless link 171 to wireless gateway 121, link 174 to transcoder proxy server 125, and link 178. Telephone 113 may be coupled to network 130 via wired link 173 to voice browser server 123, link 177 to transcoder proxy server 125, and link 178. Cell phone 114 may be coupled to network 130 via wireless link 175, cellular gateway 122, link 176 to voice browser server 123, link 177, transcoder proxy server 125, and link 178.

Any conventional protocols may be used for communication among the functional blocks shown for system 100. Each logical and physical protocol for each link discussed above is implemented with a portion of the protocol functions at the ends of the link. Suitable protocol functions are described in Table 1, below. Gateways 120 may cooperate with access devices 110 to support connection service or connectionless service.

TABLE I

| Access Device I/O Functions | Gateway Protocol Functions |
|---|---|
| Workstation 111 receives data (e.g., messages and | ISP gateway 124 provides messages (e.g., |
| files) for presentation to the user. At a minimum, | TCP/IP) on link 170 that may be interpreted |
| workstation 111 presents received data through a | by a browse process in workstation 111 as |
| conventional browse process (e.g., Internet Explorer | data in a hypertext or markup language (e.g., |
| marketed by Microsoft) for a visual presentation | HTML or XML). The manner of presentation |
| (e.g., text, graphics, animations, or video) on a | may be effected by in-line style specifications |
| monitor. Workstation 111 may include speakers, | or by references to other files (e.g., cascading |
| convert data to analog audio, and drive the speakers. | style sheets in HTML or extended style sheet |
| When link 170 is a LAN or cable TV carrier, | language (XSL) in XML). Style |
| workstation 111 may operate with data, video, or | specifications may direct text and graphics |
| television signals. Data received may be in a | and/or direct audio, video, and TV |
| markup language (e.g., HTML or XML) interpreted | presentation. Style specifications may be |
| by the browse process. Workstation 111 sends data | retrieved from any server 140, any gateway |
| that originates as user keystrokes on a keyboard, | 120, or maintained on workstation 111. |
| user operation of a pointing device (e.g., mouse | Gateway 124 may accomplish protocol |
| movements and mouse clicks), speech into a | conversion between link 170 (e.g., HTML, |
| microphone, data from a file, or video from a | TELNET, UDP) and link 179 (e.g., XML, |
| camera. A browse process may convert such inputs | TCP/IP). Gateway 124 provides message |
| into requests for information (e.g., a URL with | routing between workstation 111 and any |
| arguments of the type described in RFC 1738) or | server (e.g., servers 140 and transcoder proxy |
| into messages (e.g., email, attachments to email, or | server 125). |
| HTTP post commands). | |
| Wireless device 112 may support link 171 as a | Wireless gateway 121 may support link 171 as |
| digital connection oriented path or as a | a digital connection oriented path or a |
| connectionless path for data exchange. Data | connectionless path; and, may support |
| received may be presented to a user on screen (e.g., | connection maintenance (e.g., monitor link |
| laptop or palmtop) as discussed above with reference | quality, retransmit, use alternate channel, |
| to workstation 111, except that such a screen on a | automatic fall-back, or re-establish link) if the |
| wireless device may have less visible area and/or | connection becomes unreliable. Gateway 121 |
| lower resolution. Wireless device 112 may include a | may support file transfer and remote |
| browse process similar in some respects to the | configuration capabilities. Gateway 121 |
| browse process discussed above with reference to | provides messages (e.g., TCP/IP) on link 171 |
| workstation 111. Wireless device 112 may include | that may be interpreted by a browse process in |
| an alphanumeric keyboard (or pen) and a pointing | wireless device 112 as data in a hypertext or |
| device (mouse or pen) to provide user input | markup language (e.g., HTML or XML). ISP |
| functions similar to workstation 111 discussed | gateway 124 may therefore provide link 172 |
| above. Also, a microphone may be included with | in an analogous manner to link 170 discussed |
| functions described with reference to workstation | with reference to workstation 111. Wireless |
| 111. Wireless device 112 may be programmable | gateway 121 may accomplish protocol |
| (e.g., by download from Internet 130) and may be | conversion between links 171 (e.g., WML, |
| used generally as a telephone or as a workstation. | WAP) and 172, 174 (e.g., XML, HTTP). |
| Telephone 113 receives analog audio signals (e.g., | Voice browser server 123 samples analog |
| dial tone, computer generated speech) and sends | audio to (a) detect frequencies of DTMF and |
| analog audio signals (e.g., user's voice, dialing | identifier the corresponding key press/release as |
| tones). Telephone 113 provides an audio user | data (e.g., a message alerting to an interface |
| interface that includes a speaker that the user listens | event, or one or more time-stamped records); |
| to, a microphone that detects the user's speech, and a | and (b) to capture user's speech as data (e.g., |
| keypad the user operates to generate dual-tone multi- | streaming audio, messages containing sample |
| frequency (DTMF) dialing signals. | data, or a file of sample data). Voice browser |
| | server 123 provides data (spoken or keyed) to |
| | network 130 over link 180 (e.g., using HTTP |
| | and TCP/IP). Voice browser server 123 also |
| | implements an audio user interface according |
| | to various aspects of the present invention as |
| | discussed below. |
| Cell phone 114 may support link 175 as a digital | Cellular gateway 122 may support link 175 as |
| connection oriented path for data exchange. Cell | a digital connection oriented path and in |
| phone 114 provides a microphone and a keypad to | addition support connection maintenance (e.g., |
| receive user input as discussed above with reference | monitor link quality, retransmit, use alternate |
| to telephone 113, but user inputs may be converted | channel, automatic fall-back, or re-establish |
| to digital signals for transport on link 175. The | link) if the connection becomes unreliable. |
| keypad may have many more general purpose keys | Cell phone 114 may be capable of receiving |
| (e.g., alphanumeric) or special purpose keys (e.g., | data for storage on cell phone 114, in which |
| TDD service for the deaf). Cell phone 114 provides | case gateway 122 may support file transfer |
| a speaker for audio output as discussed above with | and remote configuration capabilities. |
| reference to telephone 113 but cell phone 114 may | Cellular gateway 122 may support protocols |
| convert data received on link 175 to analog audio to | on link 176 that are identical to protocols used |
| drive the speaker. Cell phone 114 may have a screen | on link 173. Cellular gateway 122 may |
| similar in function to the screen of wireless device | accomplish protocol conversion between links |
| 112, though typically much smaller with lower | 175 (e.g., proprietary protocols of various cell |
| resolution and lower color visibility, | phone networks) and 176 (e.g., analog audio, |
| | or Wireless Application Protocol (WAP)). |

Gateways and servers typically comprise computers having storage capacity and/or special purpose hardware and software for efficient data access and network communication. For example, each functional block of gateways 120 and servers 140 may consist of multiple computers having disk storage subsystems, communication interfaces (e.g., modems, radio transceivers) and network interfaces (e.g., T carrier) that may be compliant with industry standards and conventions adapted for use on the Internet. In an alternate implementation, workstation 111 comprises equipment similar to gateway and server equipment and vice versa. In other words, gateways, servers, and workstations may be distinguishable by the functions performed and these functions may be primarily dependent on the software that operates on each of these otherwise general purpose computers.

Each of the computers of system 100 (including embedded computers in wireless devices, telephones, and cell phones) may include functions performed in software (e.g., including firmware) collectively referred to herein as processes. Processes may include an operating system and a set of application programs suitable for the functions being performed. Application programs may include hardware interface specific processes (e.g., drivers) as well as processes suitable for simultaneous use by several processes or threads. Processes may be integrated with the operating system or loaded and maintained separate from the operating system. Processes, including the operating system, may be implemented in firmware and for some functions in circuitry.

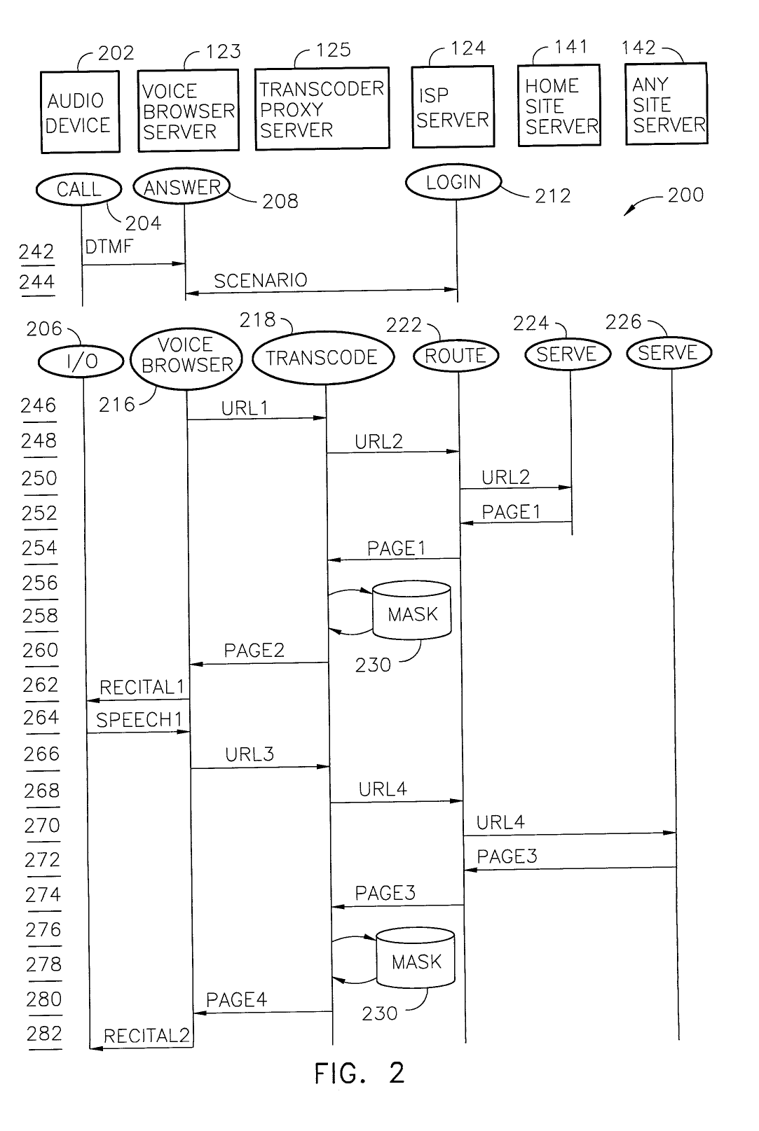

A message sequence provided by processes operating in a system according to various aspects of the present invention may provide an audio user interface. An audio user interface, inter alia, permits user access to information stored on a network (e.g., navigation of the Internet by following hypertext links). For example, in message sequence 200 of FIG. 2, processes cooperate to receive a telephone call from a user of an audio device and to provide an Internet web page via a link identified by the user. For clarity of explanation of an audio user interface, the Internet and its conventional protocols perform the functions of network 130.

Audio device 202 represents any access device having audio input/output (I/O) capability and the ability to participate in an audio telephone call. Call process 204, performed by audio device 202, performs all conventional steps to initiate a telephone call to voice browser server 123. Answer process 208, performed by voice browser server 123, performs all conventional steps to accept the call. After the call is established, call process 204 provides (step 242) identification (e.g., via DTMF signaling initiated by the user or automatically by call process 204) sufficient for answer process 208 to complete a conventional login scenario (step 244). Login process 212, performed by ISP server 124, receives and responds to the login scenario to establish a session on ISP server 124 for the user of audio device 202. Any conventional process may be used by call process 204, answer process 208, and login process 212. In an alternate implementation, a session is implied by system operation (e.g., dedicated links) and steps 242 and 244 are omitted.

Processes 216-226 may be performed as shown by five servers in separate physical locations. In an alternate implementation, process 216-222 may be performed by a single server at one location. Independent servers are preferred for higher throughput for each of processes 216-222. Processes 212 and 222-226 may include conventional software, for example, the Apache web server marketed by the Apache Software Foundation. Processes 204 and 206 may be accomplished by circuitry of a conventional analog telephone.

At a time after the session is established, (e.g., in response to interprocess messaging initiated by answer process 208) voice browse process 216, performed by voice browser server 123, requests information (step 246) expected to be provided by a server 140 on network 130. The initial request may correspond to a “home” page. The request may be made by addressing a message to transcode process 218 that identifies the requested page. In an Internet implementation, the request includes a Uniform Resource Locator (URL) with arguments (URL1 at step 246) of the type described in RFC 1738 (Request For Comment available from the W3C). URL1 may include indicia of identification of the address of transcoder proxy server 125; the address of ISP server 124; the address of home site server 141; the requested page from home site server 141; the address of voice browser server 123; and the type of process 216 as an agent.

Transcode process 218, performed by transcoder proxy server 125, generally restates information from URL1 to prepare URL2 (step 248). URL2 is a URL of the type described above that may include indicia of identification of the address of transcoder proxy server 125; the address of ISP server 124; the address of home site server 141; and the requested page from home site server 141, which is sufficient to obtain the desired home page.

Route process 222, performed by ISP server 124, performs conventional routing of requests. For example, route process receives URL2 (e.g., according to HTTP and TCP/IP protocols) and provides a request (substantially the same as URL2) to serve process 224 (step 250).

Serve process 250, performed by home site server 141, performs conventional search, access, and response functions to satisfy incoming requests. For an Internet implementation, serve process 224 provides a web page (PAGE1) that includes information in a markup language (step 252) having tags. PAGE1 is typically suitable for presentation on a workstation having a relatively large screen, color monitor.

Route process 222 routes PAGE1 on receipt from process 224 to transcode process 218 (step 254). Route process 222 typically does not revise the information being routed.

On receipt of PAGE1, transcode process 218 prepares a substitute page (PAGE2) and transmits the substitute page to voice browse process 216 (step 258). The operations necessary to produce PAGE2 are generally referred to as transcoding. PAGE2 may include information that has been summarized from the information of PAGE1, selected from the information of PAGE1, annotations, and restatements of the information of PAGE1. PAGE2 may be provided in any markup language. Preferably, transcode process 218 uses the identity of voice browse process 216 to determine a suitable markup language. For example, when voice browser server 123 performs multiple instances of more than one browse process and some browse processes accept HTML while others accept XML, transcode process 218 prepares PAGE2 in a markup language corresponding to indicia of identification received in URL1, as discussed above.

Transcode process 218 summarizes information when the amount of information provided in step 252 exceeds limits of magnitude and/or complexity. The resulting summary may be hierarchical. For example, if PAGE1 included 4 news stories, state and local weather, and stock market averages, a set of pages may be prepared of which PAGE2 is a member. PAGE2 may be prepared to include merely headlines of each of the news stories each followed by a link to the news story in full; a link to state weather; a link to local weather; and a link to stock market averages. Other members of the set may include, for example, PAGE2.1 (a news story); PAGE2.5 (a state weather report); PAGE2.7 (a list of averages); PAGE2.7.1 (DOW volume, closing average, highest average, and lowest average); and PAGE2.7.2 (NASDAQ volume, closing average, highest average, and lowest average).

Information may be selected from information received at step 252. In other words information may be excluded from appearing in PAGE2 (or a lower level hierarchical member of the set, as discussed above). Such information may not be suitable for the user interface (e.g., not suitable for audio, or too large for the small display area) employed on device 202. For example, there may be no description of a bitmap element of PAGE1; or, there may be no description of links that appear in several places on PAGE1 so as to avoid confusing the user with unnecessary redundancy.

Annotations may be added before and/or after information elements received at step 252. For example when PAGE1 includes a daily change of Dow Jones Average stated as +139.4, PAGE2 may include information describing the number 139.4 as follows “an increase of 139.4 points”. The words “an increase of” may replace the “+” and the word “points” may be added”. Annotations improve perception of the information by the user of audio device 202.

Restatements of information may include conventional transcoding operations, as well as operations desired for better presentation of information to the user of device 202. For example, when PAGE1 includes an animation or marquee text, PAGE2 may be prepared to include a restatement of the text in full without regard to the original animated or scrollin presentation in PAGE1. Further, when PAGE1 includes in-line scripts (e.g., style information or references to cascading style sheets) or program code information (e.g., reference to a JAVA applet, or a common gateway interface (CGI) command), transcode process 218 may prepare a portion of PAGE2 to represent a suitable substitute function that is compatible with voice browse process 216.

Transcode process 218 is directed to perform summarization, selection, annotation, and restatement, inter alia, according to guidance prepared, stored, retrieved, and referenced in accordance with various aspects of the present invention. Guidance, represented for example as MASK database 230 in FIG. 2, differs from a conventional style sheet in several ways. A conventional style sheet (e.g., written in CSS for HTML or in XSL for XML) must be identified by a reference appearing in the information (e.g., part of PAGE1). By contrast, PAGE1, according to various aspects of the present invention, need not contain any reference to guidance of database 230. A browse process receives content for presentation and refers to a conventional style sheet to interpret tags of the markup language of the received content. By contrast, guidance of database 230, directs a transcoder process how to prepare derivative content to be input to a browse process. The transcode process receives content for transcoding in a first markup language and refers to guidance in a second markup language for directing how to prepare an output to a browse process in the same or a different markup language than the first markup language. Consequently, the second markup language, according to various aspects of the present invention, includes tags that direct functions not possible or meaningful with respect to the use of a conventional style sheet.

Transcode process 218, on receipt of indicia identifying the desired information to be obtained via ISP server 124 (e.g., URL1) or on receipt of indicia identifying the information received from ISP server 124 (e.g., PAGE1 title), retrieves suitable guidance from database 230 (steps 256-258). Summarization, selection, annotation, and restatement, as discussed above, are then accomplished based on the information of PAGE1 to produce PAGE2. PAGE2 may conform to a voice markup language (e.g., VoiceXML or a proprietary voice markup language). Transcode process 218 then provides PAGE2 to voice browse process 216 (step 260).

Voice browse process 216 may include a conventional text-to-speech (TTS) capability having an input queue and an analog audio output capability. For example, voice browse process 216 may include Microsoft SAPI marketed by Microsoft Corp. Voice browse process 216 parses the incoming information sent by transcode process 218 in a markup language (e.g., PAGE2); substitutes and adds corresponding information according to conventional audio style sheets and other configuration settings; loads the TTS queue and provides an analog signal (RECITAL1) to I/O process 266 of audio device 202 (step 262).

Voice browse process 216 responds to DTMF signals from audio device 202 and/or speech originating with the user of device 202 (step 264). Voice browse process 216 may include a conventional speech recognition (SR) capability having an analog audio input. Speech by the user may cause I/O process 206 to provide an analog audio signal SPEECH1 to voice browse process 216. For example, consider RECITAL1 to have caused I/O process 206 to drive a speaker in audio device 202 with the audio message “press or say 1 for local weather” whereupon the user responded saying “one” and I/O process 206 provides an analog audio signal (SPEECH1) corresponding to “one”. Voice browse process 216 responds accordingly to determine a URL that provides local weather (step 266) and sends the URL (along with the information described above with reference to step 246) (URL3) to transcode process 218.

Transcode process 218, in a manner analogous to operations performed as discussed above with reference to step 248, determines a suitable URL for local weather and sends (step 268) the URL to route process 222 (e.g., URL4). Route process 222, in a manner analogous to operations performed as discussed above with reference to step 250 sends (step 270) the URL (e.g., URL4) to serve process 226 of any site server 142. Server 142 responds with information (e.g., PAGE3) in a markup language (step 272) which is sent via route process 222 without substantial revision to transcode process 218 (step 274). Transcode process 218, in a manner analogous to operations discussed above with reference to steps 256-260 prepares and sends information to voice browse process 216 (e.g., PAGE4) in a markup language (steps 276-280). Voice browse process 216, in a manner analogous to operations discussed above with reference to step 262, prepares and sends an analog audio signal (RECITAL2) to I/O process 206 (step 282) to convey to the user the information corresponding to the requested page from any site server 142 (e.g., state weather information as summarized, selected, annotated, and restated).

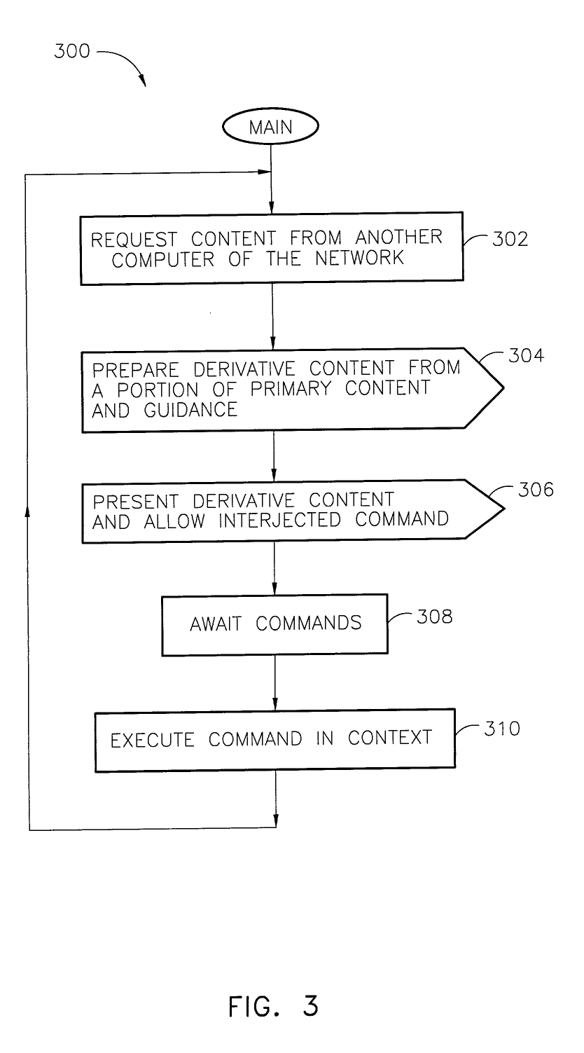

A method of providing a user interface according to various aspects of the present invention provides information adapted for audio presentation and/or adapted for a limited display. Such a user interface may accept commands in audio or as keystrokes for navigation to other information for presentation. Accordingly, a computer may perform method 300 of FIGS. 3-6 beginning by requesting content from another node of a computer network (step 302). Content means information in any form. Content is provided in messages (e.g., a page, streaming audio, or streaming video) or objects (e.g. a file, or a downloaded executable program, applet, or script). Content may refer to a home page of the Internet, as discussed above. The request may be in accordance with any conventional protocol, including by providing a URL as discussed above at step 246.

Derivative content is prepared (step 304) based on at least a portion of the so-called primary content requested and received in the previous step. Derivative content may be in stand alone (e.g., a single message or file) or streaming format (a series or set of messages or files). Derivative content may take the form of a page, as discussed above (e.g., PAGE2). Guidance for preparing the derivative content may be integral to (e.g., like conditional in-line styles), referenced by (e.g., like external style sheet), or separate from the primary content. In one implementation, the primary content makes no reference to guidance. For example, as described above, stand alone derivative content (e.g., PAGE2 or PAGE4) may be prepared based on primary content (e.g., PAGE1 or PAGE3) in accordance with guidance (e.g., database 230) that is separate from and not referred to from the primary content.

The derivative content may be presented while allowing the interjection of a command (step 306). The command may originate from a user to which the presentation was being directed, from a user monitoring the presentation for someone else, or from an automatic process (e.g., automatically sequencing a device used for advertising, warning, entertaining, or teaching based on external criteria such number of passers by, number in attendance, attrition in attendance, or time of day). Interjected commands may be initiated by operation of a keypad (e.g., of 113 or 114), a keyboard (e.g., of 111 or 112), or speech (e.g., at 111, 112, 113, or 114), for example, as discussed above. In one implementation more than one access device is simultaneously in use by the same user. For example, a monitor of workstation 111 may receive a presentation for use at the same time by the same user of a device 112, 113, or 114. Commands may be of the type described in Table 2.

TABLE 2

| | GUI Action | | |
|---|---|---|---|
| | Input to a | | |
| | Visual | Speech Input to a Voice | Keypad Input to a Voice |
| Command Description | Browser | Browser | Browser |
| Present information from | Back button | “Go back” | 0 0 |
| the immediately | | | |
| preceding page. | | | |
| Present information from | Pull vertical | “Go to top” | 0 1 |
| the top of the current | scroll bar to | | |
| page. | top. | | |
| Follow the current link. | Click on | “This link” | 0 2 |
| | desired link. | | |
| Follow the previous link. | Click on | “Prior link” | 0 3 |
| | desired link. | | |
| Skip forward in the text- | Space bar. | “Fast forward” | 0 4 |
| to-speech queue 2 | | | |
| sentences. | | | |
| Skip backward in the | Shift-space | “Rewind” | 0 5 |
| text-to-speech queue 2 | bar. | | |
| sentences. | | | |
| Accept a new page | Click in | “New URL” | 0 6 |
| address. | address box. | | |
| Speak to the voice | | | 0 7 |
| system operator. | | | |
| Continue the presentation | | “Continue” | 0 8 |
| after speaking to the | | | |
| operator. | | | |
| Mute the microphone | | | 0 9 |
| and take only keypad | | | |
| commands. | | | |
| Present information form | Refresh button | “Repeat” | * |
| the current page again. | | | |
| Provide operating | Help button | “Help” | 0 |
| instructions. | | | |
| Present a list of available | | “Give me the links” | # |
| links. | | | |
| Identify a link. | Underscored | Repeat exactly what the | 1 to 99 |
| | words | speech engine said when the | |
| | | link was presented; or say the | |
| | | name of the link number | |
| | | (e.g., “three”). | |
| Accept text entered by | Keyboard | Say the name of each letter to | Press a two digit |
| the user. | input | spell out the text desired to be | designation for each |
| | | input (e.g., to enter “cod” say | letter. The first digit is |
| | | “see oh dee”). | the three letter group. |
| | | | The second digit is the |
| | | | position in the group. |
| | | | For example, “cod” |
| | | | would be 23 63 31 |
| | | | because the groups are 2 |
| | | | for abc, 3 for def, etc. |

When the presentation has been completed (audio or visual), and no user command has interrupted the presentation, further steps of the method may be delayed (step 308) for a suitable time to give the user opportunity to give any suitable command as discussed above. Upon lapse of the delay or on entry of a command, the command (or a default command) may be executed (step 310) within the context of the current presentation (e.g., “Go back” is relative to the current presentation). After command execution, the method is repeated beginning with step 302.

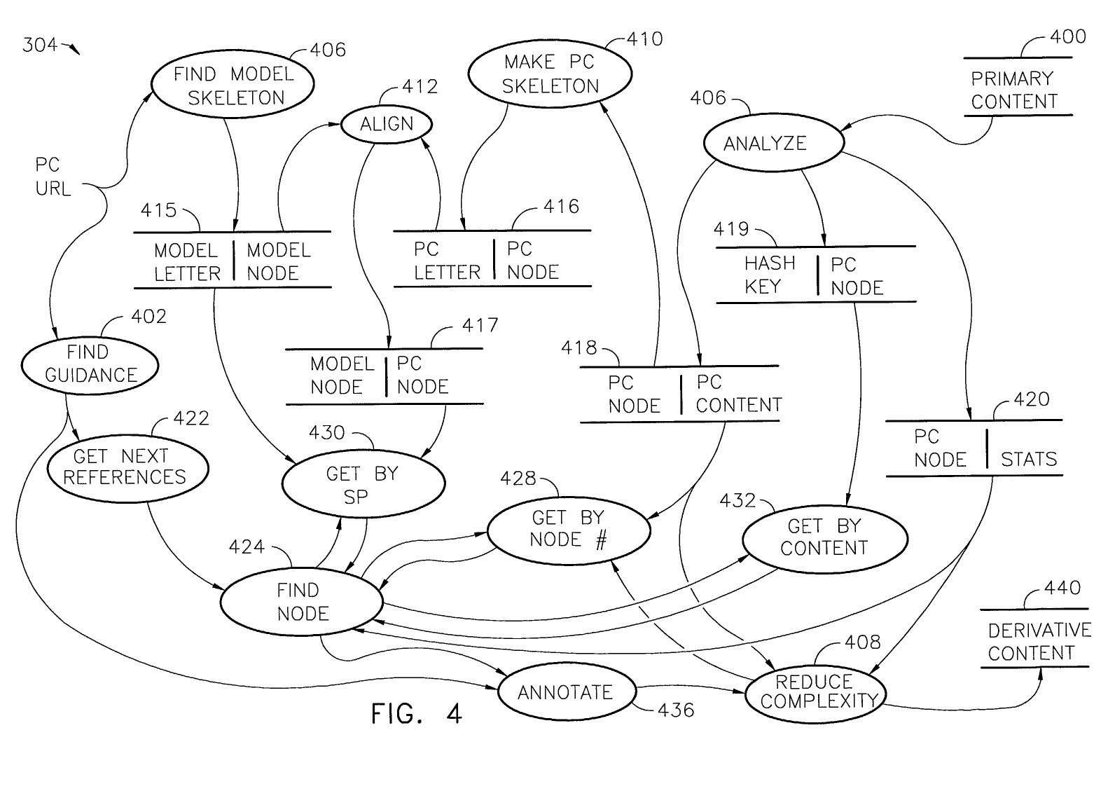

Preparation of derivative content may be accomplished according to various aspects of the present invention according to a method comprising one or more of the steps of: obtaining content for presentation in accordance with guidance, locating a node in accordance with the guidance, and reducing the complexity of content to be presented. For example, step 304 of method 300 may be accomplished by the cooperation of several processes illustrated by the data flow diagram of FIG. 4 to produce derivative content 440. Process 304 receives as inputs primary content 400 (e.g., one or more files, buffers, or messages, as discussed above) and an address of the primary content (PC), for example, a URL (PC URL). Process 304 includes find guidance process 402, find model skeleton process 404, analyze primary content process 406, reduce complexity process 408, make primary content skeleton process 410, align skeletons process 412, get next references process 422, find node process 424, get node by skeletal position process 430, get node by node name process 428, get node by content match process 432, and annotate process 436. Each process 402-436 may be performed by transcoder proxy server 125 from time to time (e.g., in serial or in parallel) at any time data for that process is suitably available.

Find guidance process 402 receives the PC URL, obtains suitable guidance associated with at least a portion of the PC URL, or obtains default guidance when, for example, suitable guidance has not been associated with the PC URL. Preferably, guidance is obtained in a markup language, for example, the MASK markup language. Guidance so found is provided to get next references process 422 and to annotate process 436.

Find model skeleton process 404, receives the PC URL, obtains a suitable description of model content associated with at least a portion of the PC URL, and provides the description to align process 412 and to get node by skeletal position process 430. The description is preferably stored in the form of a tagged skeleton of the MASK markup language. The skeleton may be included with the guidance for convenience of access. In such an implementation, find model skeleton process 404 may be omitted and find guidance process 402 may provide the skeleton as needed by other processes.

When found, the description of model content may be provided as records 415. The description of model content includes an association between a descriptive identifier and a node identifier for each node of the model content. For example, records 415 provided by find model skeleton process 404 may include for each model node: a single printable character as the descriptive identifier (MODEL LETTER) and a printable hyphenated digit string as the node identifier (MODEL NODE).

The method used for finding guidance need not be identical to the method for finding a suitable description of model content. In one implementation, guidance includes a reference to a suitable description of model content; facilitating a many to many relationship between records (or files) containing guidance and records (or files) containing descriptions of model content. Access to either guidance or a description of model content may in addition be based on information from a user account including for example the type of device (or preferences established by the user for a device having a particular identification) used in step 302 for which the derivative content is to be prepared.

Analyze primary content process 406 reads primary content 400 and prepares records 418 for use by make PC skeleton process 410 and get node by node name process 428; records 419 for use by get node by content match process 432; and records 420 for use by find node process 424 and reduce complexity process 408. Records 418, 419, and 420 may be organized in any conventional manner including, for example, in a database of the type known as a document object model (DOM). The DOM may be stored as a conventional database (e.g., relational or star). Information in the form of a DOM may exist in memory in any suitable storage format of including array, linked list, graph, tree, data structures, combinations and equivalents. Typically, a DOM includes a data structure representing a tree or graph having nodes, branches, and leaves. A leaf (e.g., an element) may be represented as a data structure comprising any object expected to be included in content (e.g., text, table, bitmap, applet, link, etc.). Nodes and branches may be represented as a data structure comprising a list (e.g., pointers to elements or other lists). One node is typically designated the root for accessing any leaf. Access to particular content (e.g., a leaf) may be accomplished with reference to a node name (e.g., “0-4-3”) by beginning at the root (“0”) and following a pointer (traversing a branch between nodes) for each portion of the node name (e.g., following the 4th pointer of the list at node “0” then following the 3rd pointer of the list at node “0-4”).

Analyze process 406 determines, for each node of primary content, an association between a node name (e.g., PC NODE, “0-4-3”) and a portion of primary content (e.g., a table). Analysis may proceed according to the nest level of tags in the markup language of primary content 400. These associations may be stored as records 418. Each record 418 may include a copy of the associated content from primary content 400. Analyze process 406 determines, for each node of primary content containing text, an association between a node name (e.g., “0-4-3”) and every word (or other meaningful symbol) used in the text at that node. These associations may be stored as records 419. Records 419 may be stored in a form of the type known as a hash table. Each record of the hash table may have a hash key for a particular word (or meaningful symbol) in primary content as a whole and a list of node names for each node having content comprising the particular word (or meaningful symbol). Analyze process 406 determines, for each node of primary content, a set of numeric descriptions (herein called node statistics) and forms an association between a node name (e.g., “0-4-3”) and the set or members of the set. These associations may be stored as records 420. Node statistics may include any quantitative properties, for example, as described below with reference to <nodestat>.

If find guidance process 402 does not find suitable or default guidance, preparation of derivative content 440 proceeds on the basis of records 418 and 429. For each node of records 418 (e.g., in depth first order from root), reduce complexity process prepares derivative content as one or more nodes of derivative content. Derivative content 440 is preferably provided in a markup language. A copy of the primary content associated with the node in records 418 may be identified as derivative content or copied to a file, buffer, or message as derivative content. If content at a primary content node is too complex, additional or substitute content for one or more nodes of derivative content may be prepared.

If find guidance process 402 did locate suitable guidance, preparation of derivative content 440 in accordance with the guidance may produce a result that is still too complex for presentation. Preparation of derivative content 440 then proceeds when records 418 are consistent with such guidance (e.g., when so indicated by annotate process 436). Reduce complexity process 408 reads records 418 and may produce derivative content 440 as discussed above.

In either case, reduce complexity process 408 determines complexity of content at a node with reference to quantitative properties of the node. For example, quantitative properties discussed above with reference to records 420 may be read by reduce complexity process 408. Reduce complexity process 408 may compare such quantitative properties to predetermined threshold values (e.g., limits). Derivative content, provided by reduce complexity process 440, primarily includes content that has been tested or prepared and determined to not exceed suitable limits.

According to various aspects of the present invention, a comparison is made in accordance with primary content and model content to facilitate, inter alia, identification of derivative content. This comparison may be made between a description of the primary content and a description of the model content. Preferably, the comparison is made between a skeleton of the primary content and a skeleton of the model content. Make primary content skeleton process 410 prepares a description of primary content in a format suitable for comparison. For example, find model skeleton process 404 provides records 415 as a skeleton as discussed above; and, make PC skeleton process 410 provides records 416 comprising corresponding information determined from records 418. The description of model content includes an association between a descriptive identifier and a node identifier for each node of the model content. Records 416 provided by make PC skeleton process 410 may include for each primary content node: a single printable character as the descriptive identifier (PC LETTER) and a printable hyphenated digit string as the node identifier (PC NODE).

Guidance is prepared with reference to nodes of the model content. To obtain corresponding nodes of primary content, a correlation is made between records 415 and 416. This correlation may be accomplished using records 415 as a whole against records 416 as a whole. For example, in an implementation having a single character for each descriptive identifier, the descriptive identifiers for the model may be aligned to the descriptive identifiers of the primary content as a correlation between character strings. Align skeletons process 412 generally associates a PC node to each model node. A conventional process may be used which accounts for mismatches such as (a) PC skeleton having nodes not found in model skeleton; (b) model skeleton having nodes not found in PC skeleton; (c) model nodes not found in the same sequence as provided in PC skeleton; (d) PC skeleton having a node (and all subordinate nodes) recognizable as corresponding to a node of model skeleton. Recognition of correspondence between nodes may be accomplished by conventional search and alignment processes, for example, of the type known as Smith-Waterman. Align process 412 provides an association between model node identifiers and PC node identifiers. This association may be provided as records 417, each record comprising a model node identifier (e.g., “0-2-6”) and a primary content node identifier (e.g., “0-4-3”).

The associations discussed above with reference to records 415-420 may be stored and accessed in any one or more conventional manners (combined or separate), including in-memory tables, arrays, and linked lists; or on secondary storage as files or a database.

Guidance may specify derived content by making one or more references to a node of primary content. When guidance is provided without a description of model content (e.g., without a skeleton of model content), references may include words (or meaningful symbols) suitable for identifying a node of primary content. When guidance is provided with a description of model content, references may include node identifiers (e.g., “0-4-3”) and positions relative to the description of model content (e.g., a skeletal position (SP)). In other words, for each node of derivative content to be prepared, guidance may include one or more references for obtaining content of a node of primary content to be included as a node of derivative content. For each node of derivative content, get next references process 422 provides to find node process 424 a set of references. Preferably, the set includes several references so that (a) if use of one reference does not identify a node of primary content, an alternate reference may be used successfully; and (b) if a reference identifies more than one node of primary content or the set of references identifies more than one node of primary content, a judgment can be made to resolve ambiguity. When find node process 424 has accomplished specification of the next node of derivative content, find node process 424 may cooperate with get next references process 422 in any conventional manner to obtain each set of references until all sets have been processed.

Find node process 424, for each set of references received from get next references process 422 identifies a node of primary content to be included in derived content. In one implementation, such identification may be made by associating a flag with a record of records 418. In an alternate implementation, the flag may specify a node number of the derived content so that the organization (e.g., sequence or tree structure) of derivative content may differ from the organization of primary content. One or more references provided by get next references process 422 may be provided in a conditional construction to facilitate if-then-else or switch (e.g., case) action by find node process 424. For example, a conditional construction may permit find node process 424 to use a first set of references if the condition is true and use a second reference (e.g., a default), if the condition fails. Conditional logic may make reference to node statistics 420, described above. Find node process 424 obtains a node identifier for each reference and resolves ambiguity among node identifiers to determine whether a node is found and if so which node (if several could apply) will be designated for inclusion in derivative content. An implementation for resolving ambiguity will be discussed below after processes 428-432.

Find node process 424 may receive from get next references process 422 a reference to a node of the model. The reference may be a node identifier in any conventional form, including a form of the type “0-3-2”). Get node by node name process 428 receives such a node identifier and obtains the associated PC node by query (or look up) on records 418. In other words, if the current primary content has a structure that includes a node named as in the model content, then the primary content node is provided by the get node by node name process 428 to the find node process 424. If no node by that identifier exists in the primary content, an indication of that result is returned instead. If the set of references provided by get next references process 422 includes more than one such node identifier, get node by node name process 428 performs corresponding queries (or look ups) and returns respective results.

Find node process 424 may receive a reference to a portion of the model content description from get next references process 422. For example when the description of model content is a skeleton (e.g., a character string) as discussed above, the reference to a portion (e.g., a substring) of the skeleton may include a starting character position and an ending character position. Get node by skeletal position process 430 attempts to identify a corresponding portion of the description of primary content. For example, a query or lookup on records 415 may provide a model node identifier associated with the starting character position and another associated with the ending character position. A query or lookup on records 416 may provide a PC node identifier for each model node identifier. Get node by skeletal position process 430 then returns the resulting one or more PC node identifiers. If the PC node identifiers comprise a tree, the root of the tree may be returned. If no PC node identifier corresponds to the skeletal positions, an indication of that result is returned instead. If the set of references provided by get next references process 422 includes more than one such skeletal position, get node by skeletal position process 430 performs corresponding queries (or look ups) and returns respective results.

Find node process 424 may receive a reference as a word, symbol, or phrase (e.g., a character string) from get next references process 422. For example, content may be identifiable by the title of a table as in “Markets Snapshot”. Get node by content match process 432 attempts to identify a corresponding PC node matching the word, symbol, or phrase. Get node by content match process 432 may form the hashed equivalent of all or a portion of the reference and perform a query (or lookup) on records 419 to obtain a PC node identifier. If no PC node identifier contains the referenced content, an indication of that result is returned instead. If the set of references provided by get next references process 422 includes more than one such reference to content, get node by content match process 432 performs corresponding queries (or look ups) and returns respective results.

As directed by guidance, find node process 424 may resolve relative referencing as to any of the returned PC node identifiers. For example, the guidance may indicate that a parent (of the node according to the reference) is intended (e.g., by syntax such as “<—” discussed below). Find node process 424 may receive zero or more PC node identifiers from processes 428-432 as discussed above. If no PC node identifier is returned, find node process 424 may produce no node information to annotate process 436 and proceed to acquire the next references from get next references process 422. If one PC node identifier is returned, then find node process 424 may present that PC node identifier to annotate process 436. When one PC node identifier corresponding to a model node (M) has been found and more than one PC node identifier is returned from processes 430 and 432, ambiguity may be resolved by the following method:

1. Consider that each reference produces a corresponding list of PC node identifiers;

2. Form a list of candidate PC node identifiers (C_{1. . . k}) where each candidate (e.g., C₁) appears on all lists;

3. Compute a score for each candidate and choose the PC node identifier having the lowest score. Each score may be computed as follows:

$${S}_{Cn} = \sqrt{{\sum }_{x = 1}^{x = min ( Q , P )} {( {C}_{{n}_{x}} - {M}_{x} )}^{2} + \{ \vert Q - P \vert \times {10}^{2} \}}$$

Where: Cₙ is a candidate having a score Sₙ.

Each C has P levels in its node name (e.g., a node name of “0-0-3-5” has 4 dimensions, one dimension for each of 4 levels).

M is the model node name having Q levels in its node name.

And, “min&Ovalhollow;” returns the minimum of its arguments.

The score represents a “distance” from the model node to the candidate node. The distance is calculated using the square root of the sum of squares of dimensional differences. When the candidate node identifier and the model node identifier are of different levels, an arbitrary dimensional difference of 10 is assigned to each level not appearing in both the candidate and the model node identifiers. In other implementations, an arbitrary dimensional difference in the range of 2 to 20 is used.

When one PC node identifier has been determined by find node process 424 (the “found node”), notice of the found node is communicated to annotate process 436. Annotate process 436 may provide revised content to reduce complexity process 408 for use as derived content. The revision applied by annotate process 436 may include summarization, selection, annotation, and/or restatement of the primary content associated with the found node. The revision may be accomplished according to any conventional editing process suitable for the content being revised. For example, additional text or audio may be added to text content.

Guidance may direct how complexity and importance are determined and consequently how derivative content is prepared. In other words, guidance may identify particular measures and limits that are to be used for determining complexity; and, may develop the derived content based on knowledge of how the average user would react to the content—what information may be considered most or least important, what information should be spelled instead of spoken for clear understanding and ease of navigation, etc.

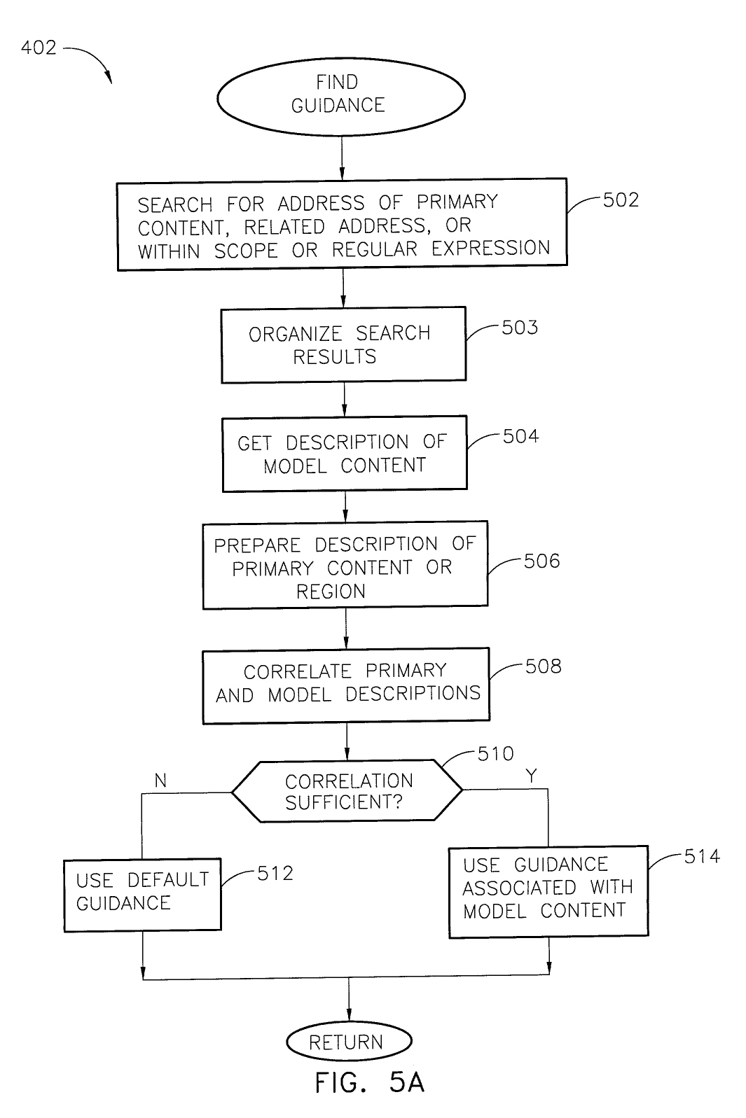

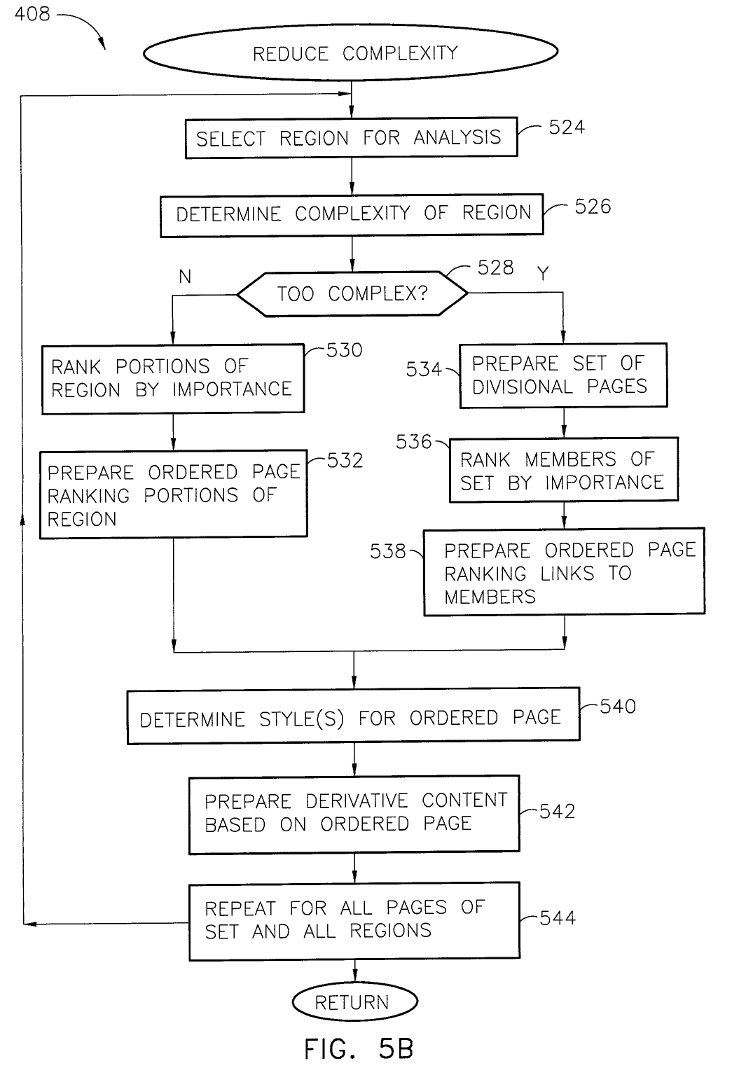

A find guidance process, according to various aspects of the present invention, includes any process that accesses guidance for use by a transcoding process. For example, find guidance process 402 may include the method of FIG. 5A for determining whether to apply default guidance. In such a method, default guidance is used when no other guidance is available as associated with the primary content. Such default guidance may include indicia of threshold conditions or limits used for analyzing content (e.g., measures and limits relative to complexity of content, measures and limits relative to expected screen size, characteristics to be tested to recognize the organization of the content). Default guidance may be accessed in accordance with the results of such analysis.

Identifying suitable guidance may be accomplished according to various aspects of the present invention according to a method comprising, one or more of the steps of accessing guidance based on an address of the primary content, an address related to the address of the primary content, an address that may be within the scope of a regular expression, and correlating at least a part of the primary content with content associated with guidance so as to identify such guidance as suitable for a region of the primary content.

In one implementation, guidance is associated with the address of the primary content (e.g., the URL of the primary content). Using the address as criteria, a query may be made of a database that provides one or more records (e.g., a file) having indicia of guidance.

In another implementation a query is formed by substituting a regular expression for part of the address of the primary content. As an example adapted for use with the Internet, content may be addressed by a URL that may include a date. By including a date, an archive of content may be maintained and accessible by navigation. Web sites that provide news may offer new content on a daily basis, addressing each page with a date code in the form of YYMMDD for year month and day. To avoid having to prepare guidance that is similarly addressed with a date code, guidance that may apply to content regardless of date code may be obtained from a database having a query that omits the date code, or restates the date code as a regular expression. In other words, when a user demands content addressed with a date code, an address suitable for query may be derived from the demanded address by substituting a regular expression for the date code. According to various aspects of the present invention, any portion of the address of primary content may be replaced with a regular expression. Several regular expression substitutions may be made to form a single address suitable for query. Exemplary regular expressions are described in Table 3. Many regular expressions of varying syntax are known. So-called wildcard characters constitute a simple type of regular expression (e.g., “*” and “?” in the filename syntax supported by MSDOS marketed by Microsoft).

TABLE 3

| Example Regular | |
|---|---|
| Expression Symbol | Description |
| [.]* | Brackets “[]” enclose a character class definition. |
| | Asterisk “*” specifies occurrences must be zero or |
| | more. Occurrence specifications may be “*”, “+”, |
| | “{n,m}” as discussed below. The period describes |
| | the character class representing all characters except |
| | newline. Thus “[.]*” represents 0 or more |
| | characters not including the newline character. |
| | Example: usa.[.]* |
| | Matches: “usa.com”, “usa.org”, and “usa.net”. |
| [\w]+ | “\w” describes the character class of letters, digits, |
| | and underscore “ ”. Plus “+” specifies occurrences |
| | must be one or more. |
| | Example: us[\w]+.com |
| | Matches: “usa.com” and “ussn.com”. |
| [\d]{n,m} | “\d” describes the character class of digits. “{n,m}” |
| | specifies occurrences must be at least “n” and not |
| | more than “m”. Thus, “[\d]{2,4}” represents at |
| | least 2 but not more than 4 digits. |
| | Example: 5/31/[\d]{2,4} |
| | Matches: “5/31/98” and “5/31/2000” |

Content available via a computer network is subject to change without notice when, for example, different computers coupled to the network are administered by independent authorities for different purposes. Content changes that are understandable when viewed on a workstation monitor (e.g., information is presented in a visually reorganized manner as to relative positions and emphasis of information) may, when analyzed from the source markup language, appear as structural and/or aesthetic changes. To assure that a consistent presentation is made to an audio device or a limited display device, predefined guidance that was suitable for content prior to a change is, according to various aspects of the present invention, identified as suitable for similar content following the change. Consequently, predefined guidance need not be revised to remain suitable for developing derived content from primary content that has changed somewhat.

In a preferred implementation, guidance is created from model content and stored and accessed using directory access structures and methods of the type known as lightweight directory access protocol (LDAP), described in RFC 2251 and 2252 with reference to ITU-T X.680 “Abstract Syntax Notation One ASN.1.”. Guidance as accessed using LDAP is stored as an entry in a directory information tree. Each entry corresponds to a node of the tree. Attributes may be associated with a node. Attributes include, for example:

1. NAME—An identifier of the guidance entry at a node, e.g., a filename.

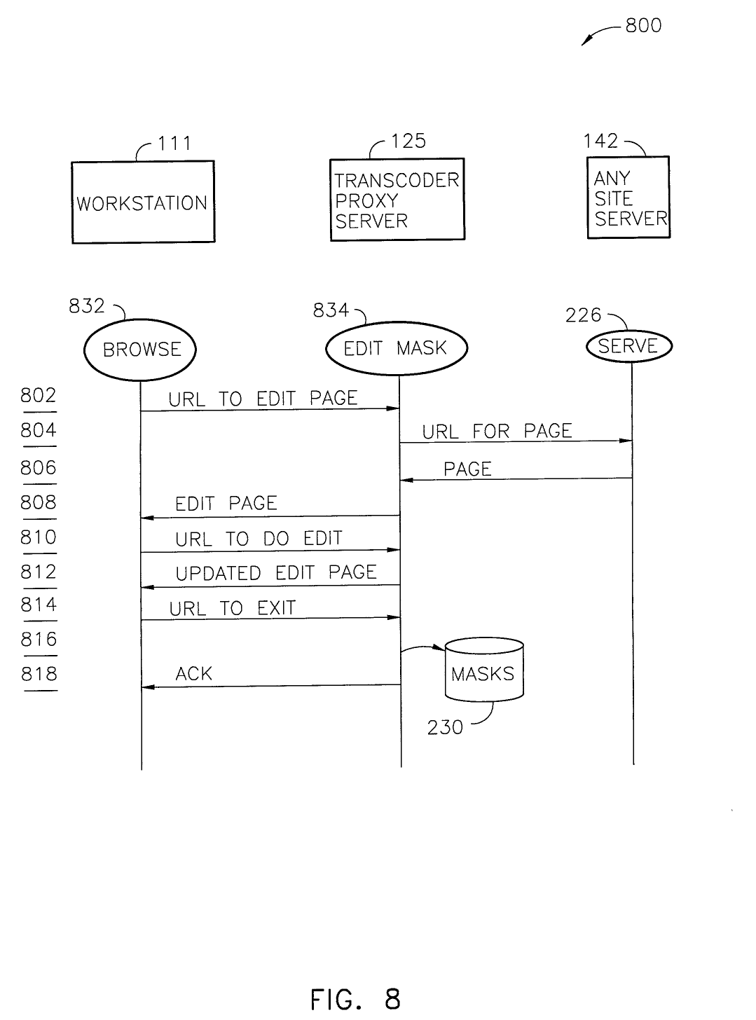

2. DESCRIPTION—A user-supplied description of the guidance. For example, a user who has prepared guidance using an editor of the type described below with reference to FIGS. 8-10 may describe the guidance in his or her own words for future reference.

3. OBJECT—The guidance itself. May be text as specified in a markup language, e.g., the MASK markup language.

4. USER_ID—An identifier associated with a user (e.g., during a registration process) and assumed to correspond to the same user during any subsequent session. By associating a USER_ID with particular guidance, different users may enjoy different derivative content from the same primary content. Each user may have defined separate guidance using an edit process described below with reference to FIGS. 8-10. A value of USER_ID may correspond to any group of users (e.g., all users).

5. MODEL_ADDRESS—The complete address of model content used in the preparation of the guidance TEXT. For example, a complete URL.

6. APPLIES_TO_ADDRESS—An address to which the guidance OBJECT should be applied. For example, an address used in step 502, such as a primary address or an address comprising one or more regular expressions. For example, the user having created the guidance OBJECT from model content, can also specify the APPLIES_TO_ADDRESS as the same as the model content URL or as a URL comprising one or more regular expressions for a wider application of the guidance OBJECT.

7. HAS_REGULAR_EXPRESSION—A flag indicating that the APPLIES_TO_ADDRESS includes at least one regular expression.

8. IS_FIRST—A flag indicating that the derivative content determined from the guidance OBJECT should be provided to the user interface first. In response to an access request using LDAP, a list of entries may be provided. Only one entry of such a list is permitted to have a set IS_FIRST flag to indicate that derivative content determined from guidance OBJECT of that entry is to be presented before derivative content as determined from guidance OBJECT at other entries of the list.

Use of the directory information tree and access protocol discussed above facilitates obtaining guidance for the preparation of derivative content as a set of pages. A search for suitable guidance conducted by find guidance process 402 (step 502) may return a plurality of entries (i.e., nodes) each having a suitable APPLIES_TO_ADDRESS attribute. Such a search may seek entries in accordance with one or more target attribute values. In one implementation, a list of entries returned from an LDAP search may be further analyzed by a script (e.g., regular expressions may be evaluated in the PERL programming language). For example, the primary address may match the respective APPLIES_TO_ADDRESS attributes of several entries exactly; or, the primary address may be within the scope of the regular expression of one or more APPLIES_TO_ADDRESS attributes. When results of a search identify more than one entry, entries may be processed in any order (step 503). A return to the calling process may be made after step 502. Preferably, an entry has been identified as a first entry, for example, as by flag IS_FIRST, discussed above. When primary content is to be presented as a series of pages (e.g., an aggregation as discussed below), the first entry may correspond to the first page of the set. When primary content is to be presented as a hierarchical set (e.g., a summarization as discussed below), the first entry may correspond to a first page having a table of contents, each line of the table comprising a link to a subordinate page of the hierarchy. A return to the calling process may be made after step 503.

After determining a suitable first entry to process, guidance corresponding to identified entries may be used to prepare derivative content in a repetitive or recursive manner until derivative content has been prepared for all identified entries.

According to various aspects of the present invention, guidance prepared with respect to model content may apply for currently requested primary content (step 302). A process for determining whether to apply such guidance to primary content may include determining whether a sufficient correlation exists between a description of the model and a description of the primary content. A description may include a subset, a summary, or a restatement of all or a portion of the content being described. The restatement may be in a markup language. The markup language used for the description may differ from a markup language used to express the content being described. In a preferred implementation, the description of the model content and the description of the primary content are prepared in a tagged element of a markup language.

According to various aspects of the present invention, guidance is captured, maintained, and implemented using a markup language herein called MASK. MASK conforms to and is therefore compatible with XML. A partial list of elements of the MASK markup language is presented in Table 4.

TABLE 4

| Guidance Tag | Functional Description | |
|---|---|---|
| <mask> ... </mask> | Encloses information conforming to the MASK language. | |
| <sklt> ... </sklt> | Encloses the definition of a skeleton. | |
| <selection> ... </selection> | Encloses the identification of each node to be presented from | |
| | primary content. Each node identification is typically enclosed | |
| | in <node> tags. | |
| <node> ... </node> | Encloses a node identification. Argument “id=” is followed by | |
| id= | a node number in the form, e.g., 0-1-0-0-2-3, as used in XML. | |
| sp=(n,m) | Argument “sp=” is followed by the position of the node in the | |
| keymasks= | skeleton, e.g., from the n^{th} character through the m^{th}. Argument | |
| remove | “keymasks=” is followed by a text string to be located in the | |
| | content. When followed by “:”, the subsequent characters may | |
| | specify relative identifications (e.g., “:<-<” means the desired | |
| | node is the grandparent of the specified node). When <node> | |
| | is used in a <description> section and argument “remove” is | |
| | specified, the identified node will not be presented. For | |
| | example, a child node row in a parent node table may be | |
| | omitted from the parent node table presentation. | |
| <description> ... </description> | Encloses annotations specified by parameterized <node>, | |
| | <header>, and <tail> tags. | |
| <header> ... </header> | Encloses a preamble annotation. The enclosure may include an | |
| | HTML reference such as <a href=“www.myart.bin”>Foo</a>. | |
| <tail> ... </tail> | Encloses a postamble annotation. The enclosure may be | |
| | similar to that described above with reference to <header> | |
| <loop> ... </loop> | Encloses script that will be repeated with the variable specified | |
| var= | by “var=” given an initial value specified by “min=”, | |
| min= | incremented by the value specified as “inc=”with each loop | |
| max= | iteration, and given a final value specified by “max=”. | |
| inc= | | |
| <if> <cond> ... </cond> | Encloses a condition that effects a branch to the first block of | |
| <do> ... </do> | script enclosed by <do> ... </do>; or to the script enclosed by | |
| <else> ... </else> | <else> ... </else> . | |
| </if> | | |
| <cond> ... </cond> | Immediately follows the <if> tag. Specifies the condition for | |
| eval= | the branch. Argument “eval=” is followed by a two letter | |
| | abbreviation as follows: | |
| | gt | A numeric evaluation: if arg1 greater than arg2 |
| | lt | A numeric evaluation: if arg1 less than arg2 |
| | eq | A numeric evaluation: |
| | | if arg1 is equal to arg2 |
| | or | Logic operators that may be used to combine other |
| | and | conditions. |
| | not | |
| | plus | An arithmetic operation that may be used to combine |
| | minus | arguments. |
| | same | A comparison of identity of string arguments: |
| | | if arg1 same arg2 |

| <arg> ... </arg> | Encloses an argument definition used for example in a | |
|---|---|---|
| | conditional expression <cond> construction. | |
| <nodestat> | Represents a result of a statistical evaluation of the content of | |
| id= | the specified node specified. The node may be specified by | |
| sp=(n,m) | one or more of the arguments “id=”, “sp=”, and “keymasks=” | |
| keymasks= | as discussed above with reference to the <node> tag. A | |
| stat_type= | conditional expression <cond> construction may refer to | |
| | <nodestat> as an argument in connection with any other | |
| | argument for effecting a comparison. The first such | |
| | comparison may be nested within a second conditional | |
| | expression <cond> construction to compare the result to a | |
| | threshold or limit. Argument “stat_type=” is followed by one | |
| | of the following: | |
| | title | Returns the text string comprising |
| | | the first sentence of the node. |
| | num_bytes | Returns the number of bytes in the |
| | | text of the node. |
| | num_words | Returns the number of words in the |
| | | text of the node. |
| | num_tables | Returns the number of tables of the |
| | | node. |
| | num_links | Returns the number of links of the |
| | | node. |
| | num_words_in_links | Returns the number of words of the |
| | | links of the node. |

The description of content for, inter alia, ascertaining suitable guidance, is captured, maintained, and used for analysis as a so-called skeleton, enclosed in the MASK tags <sklt> and </sklt>, described above. A skeletal description, according to various aspects of the present invention, emphasizes the structural aspects of content (e.g., hierarchy of nodes and nesting of tables) and de-emphasizes the information conveyed by the content (e.g., particulars of a news story or stock price). Consequently, correlation of skeletal descriptions is efficiently accomplished by any conventional technique of string comparison and alignment, as discussed above with reference to process 412. A partial list of elements of a skeletal description are described in Table 5, adapted for description of content expressed in the HTML markup language. By using a single character (e.g., one byte) for a structural feature (e.g., the beginning of a table definition), a compact description results for efficient generation, maintenance, and analysis.

Make PC skeleton process 410 may refer to statistics 420 for each node to determine a suitable description for the respective node. When a node includes a variety of features (e.g., a mix of text, digits, and links), one description may be chosen to correspond to the predominant feature. The descriptions below may be understood to refer to the predominant feature, for example, “—” corresponds to a node having predominantly links, though text and digits may also be present.

TABLE 5

| | Corresponding Feature Of | |
|---|---|---|
| Skeleton | Content In Markup | |
| Symbol | Language | Description |
| H and h | <html> and </html> | Encloses content written in HTML. |
| B and b | <body> and </body> | Encloses the body of an HTML document |
| T and t | <table> and </table> | Encloses a table. |
| R and r | <tr> and </tr> | Encloses a table row. |
| D and d | <td> and </td> | Encloses a table cell |
| F and f | <form> and </form> | Encloses a form. |
| I and i | <input> | Defines an input element such as a radio button or text |
| | | box. |
| P and p | <p> and </p> | Encloses a paragraph. |
| U and u | <ul> and </ul> | Encloses an unordered list. |
| O and o | <ol> and </ol> | Encloses an ordered list |
| L and l | <li> and </li> | Encloses a list item. |
| V and v | <div> and </div> | Encloses division within an HTML document. |
| Y and y | <layer> and </layer> | Encloses the definition of a layer. |
| * | text | Represents a passage of text of 300 words or more. |
| $ | text | Represents a passage of text of 6 to 299 words. |
| % | text | Represents a passage of text less than 6 words. |
| # | digits | Represents any number of digits forming a numeric |
| | | value or a date in numeric format. |
| @ | link | Represents a link comprising 6 or more words |
| - | link | Represents a link comprising less than 6 words. |

As discussed above, preliminary to ascertaining a correlation between model content and current primary content, a description of model content may be obtained (step 504) as associated with an address (e.g., steps 502 and 503). The description of model content may be a tagged element in the OBJECT attribute which comprises text in a markup language. A description of primary content (or a region of primary content) is prepared (step 504) as discussed above with reference to process 410.

Conventional string alignment and comparison may be used to determine an extent of correlation (step 508) between the skeletal description of the current content (e.g., retained in a temporary memory) and the skeletal description of the prior content (e.g., retrieved from the <sklt> . . . </sklt> tagged section of guidance in the MASK markup language). A conventional Smith-Waterman process may be used.

In an alternate implementation, a historical model of the type known as a hidden Markov model may be used. The historical model may reflect the probability of particular content (e.g., a sequence of structural features) appearing at a particular position in the skeletal description, at a particular screen location, or in logical or positional association with other particular content. The historical model may be developed with reference to one or, more preferably, many examples of primary content. To determine whether sufficient correlation exists between current primary content and the historical model, a second model of the current primary content may be prepared and the historical and second models may be compared in any conventional manner.

If the extent of correlation is sufficient, the guidance associated with the description of prior content is returned as suitable guidance (step 510 and 514). Otherwise default guidance may be returned (steps 510 and 512). In determining whether the correlation is sufficient, a logical or numeric threshold and comparison may be used. For example, if it is sufficient to find a match, then the binary logical assertion that a match has been found determines the result of the test (step 510). In an alternate implementation, a weighted sum of the extents of matches found (e.g., allowing for intermittent mismatches to also be present in the correlation) may be compared to a threshold numeric value. When the weighted sum exceeds the value, for example, sufficient correlation may be concluded. In another implementation, probabilities derived from a model are combined in any conventional manner to conclude sufficiency. For example, if matches are found in portions associated with a low probability of change or mismatches are associated mostly with portions that have a high probability of change, sufficient correlation may be concluded.

A reduce complexity process according to various aspects of the present invention includes any process that reorganizes content for better navigation. Because content to be presented is expected to be too complex to present in audio or on a limited display, the content is reviewed to recognize its organization. Complex content is content that is difficult for an average user to understand or navigate when presented in audio; and content that is difficult for an average user to understand or navigate when presented in part on a screen of limited display area and/or resolution. Navigation includes the process of understanding the presentation, recognizing links, selecting a desirable link, and commanding access to the information associated with the desired link. Complexity may interfere with one or more of these steps of navigation.

If the organization permits recognition of regions within the content, further analysis is accomplished for each region more or less independently. A region is a portion of the content having few contextual associations to other portions of the content. Contextual associations may be structural or aesthetic. Structural differences may include differences in presentation, for example, text presented in a first table may be fairly dissociated from text not in the table, text placed at a distance from the table, and text presented in a second table. Aesthetic differences may include differences in appearance, physical location, or arrangement, for example, when the content (e.g., expressed in a markup language) specifies a first passage of text and links on a first background and a second passage of text and links on a second background, the association between the first and second passages of text may be treated as weak by implication and a different region may be defined for each passage. Many pages have headline information at the top and legal notices and general information presented at the bottom of a large screen. Blank space may indicate a separation of portions. Relative physical location may indicate importance. Having recognized differences defining regions, and having recognized probable importance that may be associated with each region, further analysis may be accomplished for each region in rank order of relative importance. Based on the above criteria, a region for further analysis is selected (step 524).

Analysis of content to be presented is accomplished to ascertain whether the selected region is amenable to further subclassification (e.g., forming a hierarchical set of pages representing the content of the region). For example, the complexity of the region may be determined (step 526) by calculating one or more measures of complexity. When the content is expressed in a markup language, measures may include number of bytes in the markup language to express the content of the region, number of bytes of content in the region, and number of links in the region.

If the region is not determined to be too complex (step 528), identifiable portions of the region may be analyzed for relative importance (step 530) and derivative content 440 may be constructed. Derivative content may include content in a markup language not necessarily the same as the markup language of primary content 400. The derivative content may include the portions of the region positioned (e.g., absolutely from screen top right corner, relatively to any desired position of the expected screen, or relatively to other portions of the region), highlighted, or sized, in accordance with the rank order of importance (step 532).

On the other hand, when the region is determined to be too complex (e.g., when one or more measures or weighted measures exceed a limit) a set of divisional members of derivative content may be prepared (step 534), each having a part of the selected region's content. The rank of importance of each divisional member may be ascertained (step 536) in a manner as discussed with reference to step 530. And, derivative content may be prepared as including a list of links to each divisional member of the set. Any suitable summarizations and annotations may accompany the links in the derivative content. Some content identified for presentation (e.g., by annotate process 436 or by primary content 400) may be omitted from the set.

Having developed derivative content in a preliminary form (steps 532 and 538), any conventional style sheet (or cascading style sheets) may be applied (step 540) to affect font, position, background, and the numerous other content properties conventionally controllable via style sheets. The derived content may be revised (step 542) for in-line styles or references may be made to style sheets in files or messages maintained separate from the derived content.

Derivative content for all divisional members may be prepared while the primary content is available and being analyzed. Alternatively, when a set of divisional members has been identified to be prepared (step 534), the first member (or summary of the set) may be prepared in step 542, and the remaining members may be prepared when demanded (e.g., a link is followed). When presenting a member of a set, a conventional cookie may be sent and or updated to simplify navigation among members of the set or to indicate that preparation of derivative content of another member is desired. Derivative content for all regions may be prepared by repeating steps 524-544 for all pages and all regions (step 544).

After step 544, control may return to the calling process.

In a preferred implementation, annotated content is stored in a DOM as discussed with reference to analyze primary content process 406 and records 418. Records 418 are retained in memory as the DOM. Reduce complexity process 408 receives notice of a PC node identifier that is ready for further processing from annotate process 436. The received PC node identifier identifies a node (corresponding to a region in step 524) for complexity determination. Children of the identified node correspond to content portions (step 530) or member pages of a set (step 534). Steps 524-538 may be accomplished by applying to the identified node a set of rules. Rules may be applied in any order or organized as nested if-then-else (or case) statements to be applied in a fixed order. Actions that may be taken according to a preferred set of rules are described in Table 6.

In Table 6, a dominant node may be defined as a node having a large percentage of the content of the primary content. The percentage may be determined using statistics (e.g., num_bytes) applied to this node divided by statistics (e.g., num_bytes) applied to the top node of the DOM. For example, a form may be dominant when the number of bytes of text content to be presented for the tag pair of this node (e.g., from <form> to </form>) divided by the number of bytes of text content to be presented in the page as a whole (e.g., from <html> to </html>). If the ratio is greater than ⅔ (i.e., 67%), the node may be considered dominant.

TABLE 6

| Predicate Action | Description | Conditions Precedent |
|---|---|---|
| DISCARD | Do not present anything | (a) when this node is substantially not text (e.g., bit |
| | from this node | map data, audio, etc.); (b) when this node has been |
| | | flagged as removed (e.g., by operation of button 916); |
| USE AS IS | Present node contents | (a) when this node corresponds to an HTML <head> |
| | without further analysis | tag; (b) when this node is a dominant HTML <form> |
| | | section; |
| AGGREGATE | Present node content in | (a) when this node and its parent are both |
| | part and indicate with a | substantially text, and this node has few children, and |
| | link that further content | this node is not designated first (e.g., flag IS_FIRST |
| | is available for | is not set), and this node's content is amenable to |
| | presentation (e.g., a link | presentation on one display screen or in one audio |
| | to “more”). | recitation; (b) when summarization has or will effect |
| | | more than a maximum number of links, the remaining |
| | | links are aggregated; |
| SUMMARIZE | Present a table of | (a) when this node is an HTML <form> section, but is |
| | contents, each line | not dominant; (b) when this node and its parent are |
| | comprising a link to a | both substantially text; and this node is not designated |
| | portion of the node | first (e.g., flag IS_FIRST is not set); and this node has |
| | content. | few children, and this node's content is amenable to |
| | | presentation on one display screen or in one audio |
| | | recitation; (c) when this node's parent is not |
| | | substantially text, and this node is substantially text, |
| | | and this node is not a dominant node, and this node is |
| | | not designated first (e.g., flag IS_FIRST is not set); |
| | | (d) when this node is a nested HTML <td> tag, and |
| | | this node has few children; (e) when this node is an |
| | | HTML <td> tag but not a nested table, and this node |
| | | is not a dominant node; (f) when this node is not |
| | | substantially text, and this node is not an HTML <td> |
| | | tag, and this node is not a dominant node; |
| ANALYZE | Do not present anything | (a) when this node is an <html> tag (e.g., a page |
| CHILDREN | at this (parent) node; yet, | having multiple <html> tag pairs); (b) when this node |
| | continue with first child | is an HTML <body> tag; (c) when this node is a |
| | node of parent node. If | nested HTML <td> tag, and this node is has many |
| | parent has content, build | children; (d) when this node is an HTML <td> tag, |
| | sub-tree and move | but not a nested table; and this node is a dominant |
| | content to children | node; (e) this node is not substantially text, and this |
| | nodes. | node is not an HTML <td> tag, and this node is a |
| | | dominant node; |

A method for presenting derivative content according to various aspects of the present invention includes any method comprising one or more steps of identifying styles suitable for audio and/or visual presentation; presenting summarized, selected, annotated, and restated content; or simultaneously acquiring and analyzing user input during presentation for processing an interjected command from the user. A method in an implementation called from step 306 of method 300, discussed above, begins by identifying one or more styles that may be suitable for the information to be presented. For example, in the system discussed above with reference to FIG. 2, voice browse process 216, having received content (e.g., PAGE2) in a markup language (e.g., VoiceXML), may identify styles (step 602) from the content (e.g., in-line or referenced) or identify suitable default styles. Default styles may be identified by processes performed by voice browser server 123 with reference to indicia of the type of audio device 202 which may be implied or explicit in prior communication (e.g., registration of device 202 and its user with the authority providing voice browsing services; or at step 242 by additional codes or cookies accessible to voice browser server 123). Style information may refer to a predefined or user defined dictionary of terms with instructions on preferred pronunciation. For particular terms, instructions may direct that the term be spelled instead of being pronounced.

After styles have been identified for application (or have been applied), two parallel execution paths may be supported. First, the recitation and/or display of derivative content (step 604) is directed to the user's device (e.g., 202).

Second, while presentation is in progress, input (e.g., audio or actuation of keypad switches) is received and accumulated for recognition (e.g., speech recognition or multiple key sequence recognition) (step 606). If the input is recognized as including a command (step 608), recitation and/or display may be interrupted (step 610). An acknowledgement of the command may also be presented. The context of the command (e.g., the time the command was initiated, or the position in the presentation (e.g., TTS queue or content being displayed)) is noted.

When the presentation is complete, when no interjected command has been identified, and when the interjected command and its context have been noted, a return to the calling process may be effected. Indicia of the interjected command, if any, and its context may be returned as well.

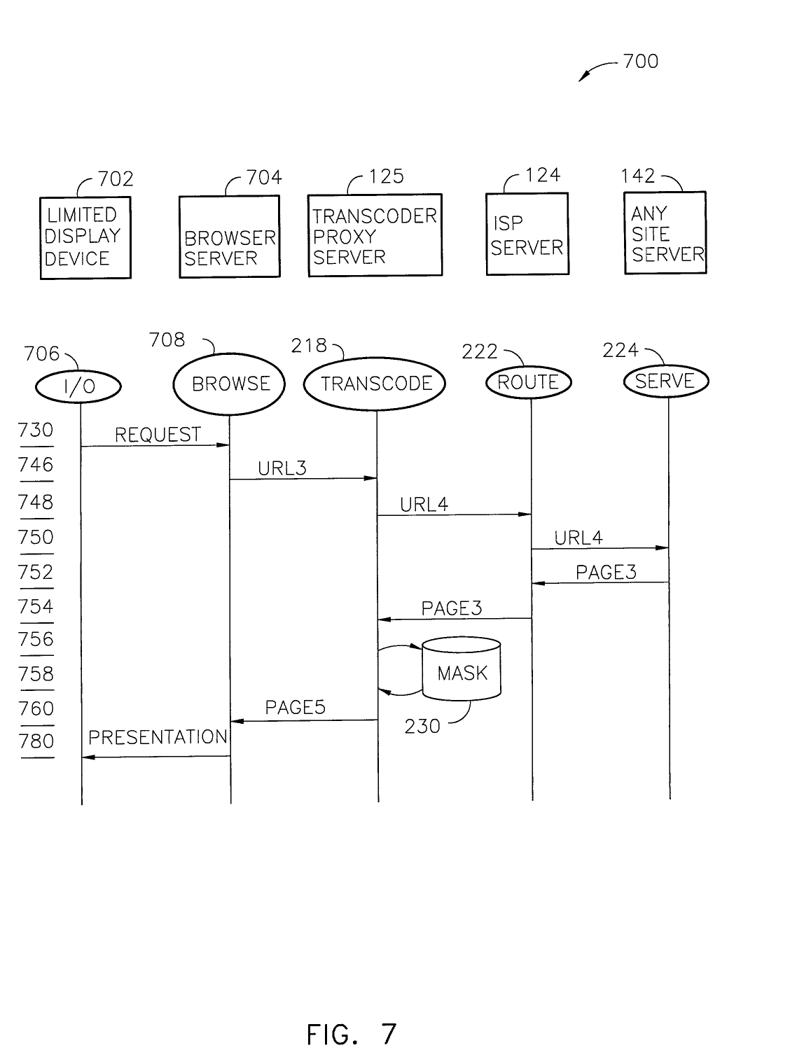

A message sequence provided by processes operating in a system according to various aspects of the present invention may provide a user interface for a device having a display of limited visible area and/or resolution (herein called a limited display device). A limited display user interface, inter alia, permits user access to information stored on a network (e.g., navigation of the Internet by following hypertext links). For example, in message sequence 700 of FIG. 7, processes cooperate to make a request for information and to present information received. For clarity of explanation, the Internet and its conventional protocols perform the functions of network 130; information is requested by following a link; and information is received in the form of a web page. Message sequence 700 presumes that a connection oriented link or a connectionless link (e.g., 171, 173, or 175) is already available (formed as discussed above or in any conventional manner) for communication and that information with a link (e.g., a hypertext link) is currently being displayed on limited display device 702.

Limited display device 702 represents any access device having, inter alia, a display of smaller area or less resolution compared to a conventional monitor of workstation 111. Examples of limited display devices include (a) wireless device 112 which may have a text only display, a monochrome text and graphics, or a pocket size color display; (b) telephone 113 which may have a video display panel having a diagonal measurement of less than 8 inches (10 cm); and (c) cell phone 114 which may have a display similar to those discussed in (a) and (b). Limited display device 702 for clarity of explanation is assumed to have minimal computing capability—merely sufficient for performing I/O process 706. I/O process 706, performed by limited display device 702, accepts user input demanding access to the information addressed by the hypertext link and sends (step 730) a suitable request to browse process 708.

In an alternate implementation, limited display device 702 may have computing capability sufficient to perform browse process 708 (e.g., Internet Explorer marketed by Microsoft for operation on wireless devices). If so, then browser server 704 may be omitted with concomitant changes to message sequence 700.

Browse process 708 includes any process capable of participating in the conventional communication protocols associated with network 130 (e.g., TCP/IP, WAP, HTTP, etc. for wireless devices and/or the Internet). Browse process 708 may be performed by browser server 704. For limited display devices of the type described above with reference to telephone 113 and cell phone 114, browse process 708 may be performed by voice browser server 123 in place of browser server 704. Analogous to the discussion above, the functions of browser server 704, transcoder proxy server 125 and ISP server 124 may be performed by any number (including one) of computers at any number of physical locations.

The functions performed by MASK database 230, browse process 708, transcode process 218, route process 222, and serve process 224 may correspond to the functions described above for messages relating to URL3, URL4, PAGE3, and PAGE4 (i.e., steps 746-760 of FIG. 7 correspond to steps 266-280 of FIG. 2). URL3 may include identification of browse process 708 so that transcode process 218 can prepare PAGE5 (in place of PAGE4 of step 280) in a form suitable for use by browse process 708.

Browse process, on receipt of information (e.g., PAGE5) from transcode process 218 (step 760) prepares information (e.g., message PRESENTATION) directing limited display device 702 to make a suitable display corresponding to the information requested (step 730). PAGE4 may be in a markup language (e.g., HTTP, XML, or WML). PRESENTATION may be conveyed via a proprietary protocol adapted for limited display device 702 (e.g., conforming to device 702's manufacturer's specifications). Tailoring for the size and/or resolution of the display of limited display device 702 may be accomplished by transcode process 218 as directed by guidance from database 230; and/or by browse process 704. Preferably, identification of the limited display device 702 and/or browse process 704 as received with URL3 (e.g., as discussed above with reference to step 246) is used by transcode process 218 to obtain guidance from database 230 so that PAGE5 requires merely application of one or more conventional style sheets to provide a suitable PRESENTATION. In other words, if the requested page exceeds the complexity suitable for limited display device 702, PAGE5 may include a member of a set of pages, as discussed above.

A system and method for preparing guidance, according to various aspects of the present invention, presents the user with a graphical user interface with which the user may retrieve information form a computer network and define guidance to be associated with the retrieved information. Guidance may then be used for an audio user interface or a limited display user interface as discussed above. For example, when the computer network includes the Internet, the user may operate a browse process to retrieve a web page and define guidance of the type described above. The user may perform operations (e.g., mouse clicks) in a graphical environment to direct preparation of guidance by automatic text generation. Text that is generated may be in a markup language, for example the MASK markup language as discussed above.

A method for defining guidance, according to various aspects of the present invention, includes any process that includes, inter alia, selecting a portion or region of information, annotating selected information, and/or creating a description of the information (e.g., a skeletal description) for use in associating guidance with the selected information. For example, message sequence 800 of FIG. 8 may be accomplished by workstation 111, transcoder proxy server 125, and any site server 142. These devices have been described above including serve process 226 performed by any site server 142. Browse process 832, performed by workstation 111 may include any information requesting and presenting program suitable for network 130. When network 130 includes the Internet, browse process 832 may include any conventional Internet browser (e.g., Internet Explorer marketed by Microsoft). MASK edit process 834, performed by transcoder proxy server 125 may be constructed using any conventional programming technology suitable for use on network 130. For example, MASK edit process 834 may be developed using known languages and interfaces including C++, PERL, CGI APIs, JAVA, JavaScript, and XWindows, to name a few.

Guidance defined during the edit session will define what and how information will be presented in derivative content. Derivative content is derived from primary content (e.g., for which the model page is a prototype) by application of guidance defined during an edit session.

Message sequence 800 will now be described assuming network 130 includes the Internet. In response to user input, browse process requests a page (step 802) from MASK edit process 834. The address of the requested page may be known by the user, or the user may be guided to the appropriate page by a hypertext link in another page that is known by the user. The URL of the requested page may include (in any conventional manner) indicia of a model page to be edited.

On receipt of the request from browse process 832, MASK edit process 834 requests (step 804) the model page (or a default page) from any site server 142. Serve process 226 returns the desire model page (step 806) in any conventional manner (e.g., in a markup language with animations, streaming audio and/or video).

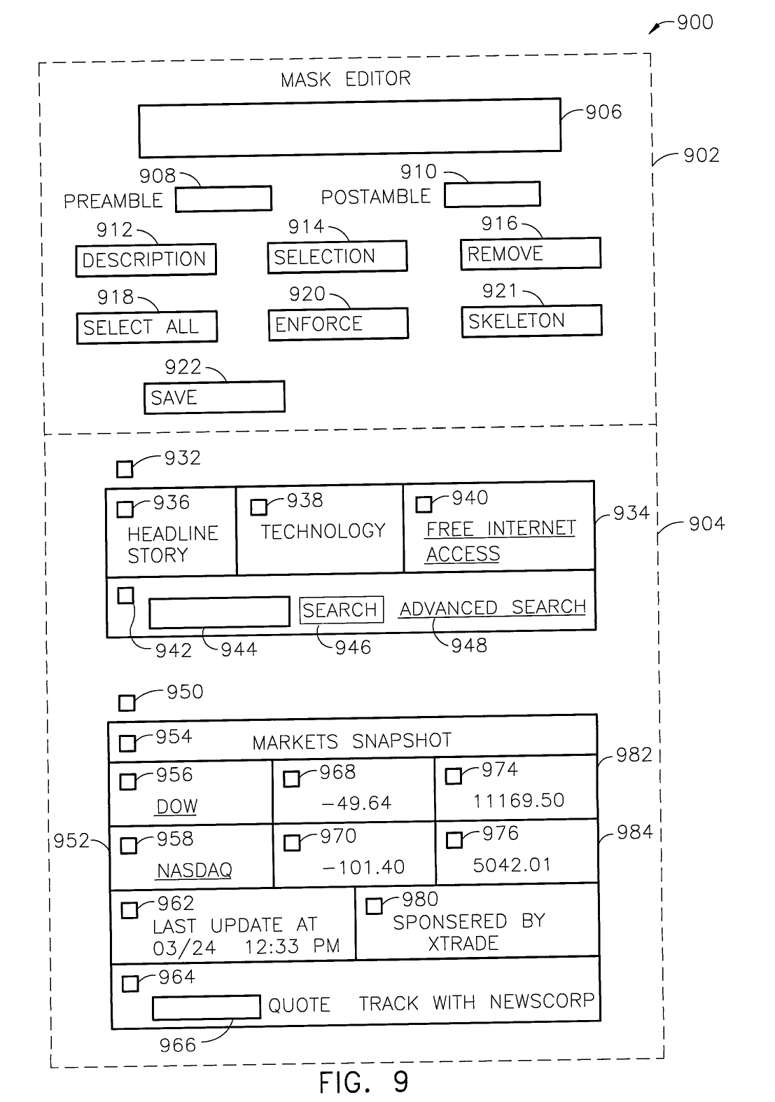

MASK edit process 834 prepares a presentation in accordance with a portion of the model page (step 808) and sends the presentation (e.g., EDIT PAGE) to browse process 832. The presentation may be made less complex in any manner as described above (e.g., as directed by guidance from database 230) or in any conventional manner. The presentation may be made using the audio user interface or the limited display user interface described above, wherein predefined guidance is associated with the EDIT PAGE. Preferably, efficient development of guidance for the model content may be obtained using a presentation that includes one or more of the elements schematically shown in screen 900 of FIG. 9 and described in Table 7.

TABLE 7

| Reference | | |
|---|---|---|
| Designation | Description | Alternatives |
| Panel 902 | Provides uninterrupted access to editor | The functions of panel 902 may be |
| | commands, statements that have been | provided by any combination of |
| | manually or automatically developed, and | conventional drop-down menus, tool |
| | entries for annotations. | bar buttons, and/or dialog boxes |
| | | having conventional tabbed pages of |
| | | widgets. |
| Panel 904 | Presents any desired portion or region of | Panel 904 and any number of portions |
| | the model page, e.g., for defining the scope | of simultaneous model pages may be |
| | or subject matter of an editor command. | presented in any combination of |
| | | conventional tiled (split screen), |
| | | framed, and windowed display |
| | | technologies. Scroll bars may be |
| | | added for panning images having a |
| | | scale too large for presentation in their |
| | | entirety in one tile, frame, or window. |
| Text box 906 | Provides visibility and entry/edit functions | Presentation may be as a wrapped text |
| | for statements or arguments, e.g., in the | string, outline formatted to illustrate |
| | MASK language. | the paired and hierarchical scope of |
| | | tags, or illustrated graphically, e.g., |
| | | using flow chart symbols. |
| Text boxes | Provide entry/edit functions for annotations. | Entry may be made in box 906 |
| 908 and 910 | | consistent with the presentation |
| | | alternatives for box 906 discussed |
| | | above. |
| Buttons 912, | DESCRIPTION - permits entry/edit of text | Tool bar buttons, dialog box buttons, |
| 914, 916, | and parameters in box 906 between | or menu items may be used in |
| 918, 920, | automatically generated <description> ... | combination or substituted for any or |
| 921, and 922 | </description> tags as discussed above. | all buttons. |
| activated, | Typically, the description section includes | |
| e.g., by a | <node>, <header>, and <tail> tags for | |
| mouse click, | annotation. | |
| | SELECTION - permits entry/edit of text and | |
| | parameters in box 906 between | |
| | automatically generated <selection> ... | |
| | </selection> tags as discussed above. In | |
| | addition, when various check boxes | |
| | described below are asserted, the content | |
| | associated with each may be automatically | |
| | specified in box 906. The selection section | |
| | typically includes one or more <node> tags. | |
| | REMOVE - features or text appearing in the | |
| | model page may be designated as not to | |
| | appear in derivative content. When various | |
| | check boxes described below are asserted | |
| | for a remove action, the “remove” parameter | |
| | is automatically added to the associated | |
| | <node> tag. | |
| | SELECT ALL - same as SELECT, though | |
| | no prerequisite check boxes need be | |
| | asserted. | |
| | ENFORCE - Enters “keymasks=” | |
| | arguments in <node> tags corresponding to | |
| | content in asserted check boxes. Each word | |
| | in the content gives rise to a separate | |
| | “keymasks=” specification. Relative | |
| | operations (e.g., “<-”) are added to conform | |
| | to the “id=” argument. | |
| | SKELETON - Creates a description of the | |
| | entire model content in text box 906 as a | |
| | suitable <sklt> ... </sklt> entry. Enters | |
| | precalculated “sp=” arguments in <node> | |
| | tags for items having asserted check boxes. | |
| | SAVE - Saves the contents of box 906 in | |
| | database 230 and terminates the edit process. | |
| | May include effectively asserting the | |
| | SKELETON button prior to SAVE. | |
| Check boxes | A mouse click in a check box selects the | Selection may be accomplished by a |
| 932 and all | associated elements for operation by an edit | mouse-drag to paint selected items or |
| boxes of | command. Box 932 selects the 2-row table | to enclose selected items in a perimeter |
| similar | 934. Boxes 936-942 select cells in table | formed during the drag. |
| appearance | 934. A selected cell may have a variety of | |
| | content elements, e.g., row 942 includes a | |
| | text box 944, a button 946, and a link 948. | |

Whenever the user has completed entry of text in a text box (e.g., 906, 908 or 910), or activates a button (e.g., 912-922, or alters the assertion of one or more check boxes, a message describing the action(s) taken may be sent to MASK edit process 834 (step 810). The message may be in the form of a URL with parameters. MASK edit process 834 may respond with an updated edit page (step 812) that presents panel 902 cleared and ready for further operations and panel 904 updated to show the effect of accumulated annotations, if any. These two operations (steps 810 and 812) are repeated as many times as desired. In response to user assertion of button SAVE 922, browse process 832 may send (step 814) a message indicating termination editing is desired. MASK edit process 834 may then post guidance to MASK database 230 (step 816) and send an acknowledgement (e.g., a predefined page) to browse process 832 (step 818).

Prior to terminating, Mask edit process 834 may analyze prompt the user to specify information used for accessing the guidance resulting from editing. For example, the user may be prompted to provide information corresponding to one or more of NAME, DESCRIPTION, USER_ID, MODEL_ADDRESS, APPLIES_TO_ADDRESS, HAS_REGULAR_EXPRESSION, or IS_FIRST, as discussed above. Edit process 834 may also supply values by analysis or default.

Guidance may be stored as one or more records in database 230 in any conventional manner. Guidance may be indexed according to the URL of the model content. Guidance may be indexed by a URL comprising a regular expression derived from the URL of the model content so that the guidance is indicated as applicable to all primary content URLs that matches the regular expression. Guidance may be stored or accessed in a hierarchical manner that maps portions of the URL to directories (or folders) having subdirectories (or subfolders). A method for accessing guidance may include the following steps:

1. Search for the URL exactly as presented (e.g., the PC URL of FIG. 4); if found quit, otherwise continue.

2. Truncate the last (child) portion of the URL. For example, “http://www.news.com/US/2000-OCT-30.htm” may be truncated to “http://www.news.com/US/”. If the truncated URL is found, quit; otherwise continue.

3. Search for a sibling of the truncated URL of step 2 and if found, use the guidance associated with the sibling; otherwise, continue. In the example of step 2, this step 3 would use “http://www.news.com/US/[.]*”.

4. Truncate the URL keeping only the scheme and the first domain designation. If the truncated URL is found, quit. Otherwise, no guidance is available. For example, derivative content 440 is prepared by the cooperation of analyze process 406 and reduce complexity process 408.

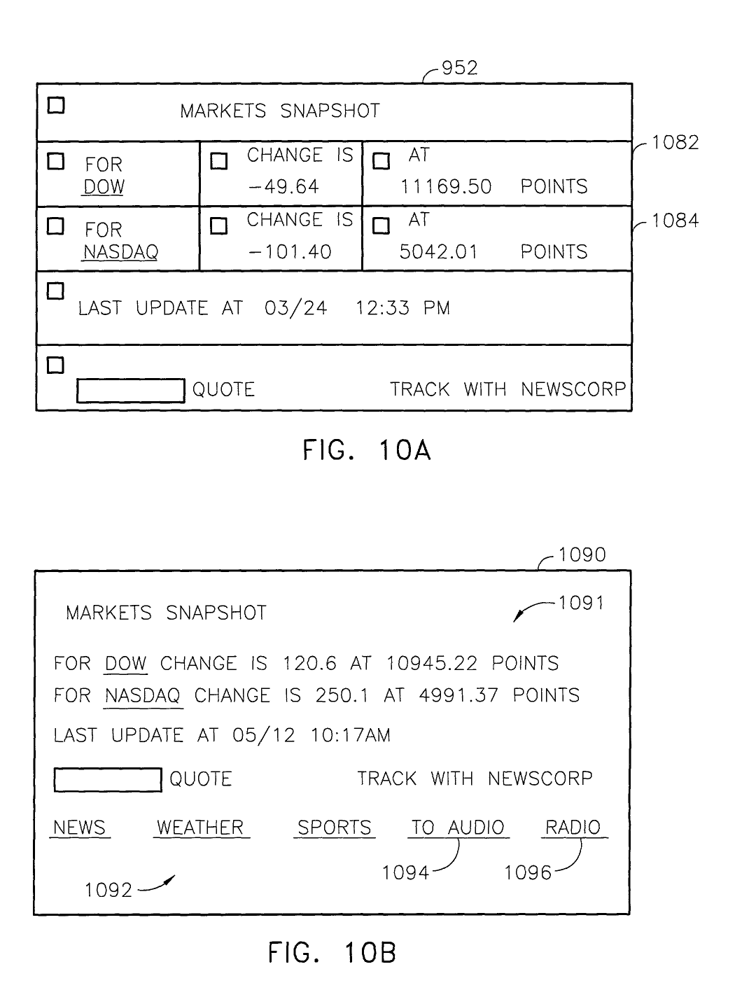

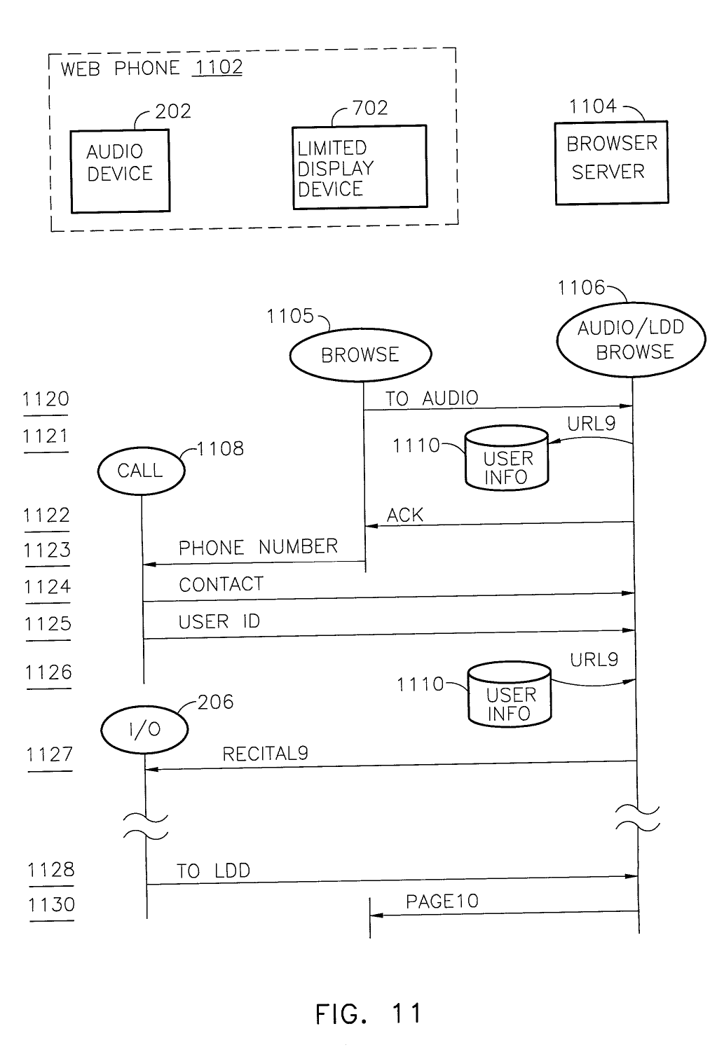

The following sequence of user inputs also described in Table 8 would produce guidance for model content (e.g., selected and annotated content) represented by the schematic display of FIG. 10A. “Click” means that the mouse left button is pressed and released when the mouse pointer is located over the indicated feature.

1. Click in box 950 to indicate that the entire table 950 is to be the subject of a subsequent operation.

2. Click button 914 SELECTION to cause table 952 to appear in the derivative content.

3. Click in box 980 to indicate that one cell of table 950 will be the subject of a subsequent operation. Click button 916 REMOVE to omit box 980 from derivative content for table 952.

4. Click in boxes 956 and 958; type “FOR” in PREAMBLE box 908; and click button 912 DESCRIPTION so that the word “FOR” will be presented (e.g., recited in audio) before the remaining content in each indicated cell.

5. Click in boxes 968 and 970; type “CHANGE IS” in PREAMBLE box 908; and click button 912 DESCRIPTION so that the words “CHANGE IS” will be presented (e.g., recited in audio) before the remaining content in each indicated cell.

6. Click in boxes 974 and 976; type “AT” in PREAMBLE box 908; type “POINTS” in POSTAMBLE box 910; and click button 912 DESCRIPTION so that the word “AT” will be presented before and the word “POINTS” will be presented after the remaining content in each indicated cell.

7. Assert only box 954 and then click button 920 ENFORCE. “Keymask=” arguments will be added to descendent nodes of table 952 in the description section and/or the selection section.

8. Click on button 921 SKELETON. A skeleton of the model content will be generated. An “Sp=” argument will be added to each node in the description and/or the selection section.

9. Click button 922 SAVE to terminate editing and save the text in box 906 as guidance. Guidance may also include data corresponding to the text in box 906. For example, the skeleton may be saved in a form that includes an association between node names and skeletal characters of the type described above with reference to records 415.

TABLE 8

| Step | Text in Box 906 After Performing the Step | Comment |
|---|---|---|
| 1 | <mask> <description> </description> <selection> </selection> </mask> | Box 906 |
| | | may be |
| | | initially |
| | | empty. |
| 2 | <mask> <description> </description> <selection> <node id=“0-0-1”> </node> | Because |
| | </selection> </mask> | box 932 |
| | | was not |
| | | asserted, |
| | | table 934 |
| | | will not |
| | | appear in |
| | | derived |
| | | content. |
| 3 | <mask> <description> <node id=“0-0-1-3-1” remove> </node> </description> | One cell is |
| | <selection> <node id=“0-0-1”> </node> </selection> </mask> | removed. |
| 4 | <mask> <description> <node id=“0-0-1-1-0”> <header> FOR </header> | Preamble |
| | </node> <node id=“0-0-1-2-0”> <header> FOR <header> </node> <node | annotation |
| | id=“0-0-1-3-1” remove> </node> </description> <selection> <node id=“0-0- | added. |
| | 1”> </node> </selection> </mask> | |
| 5 | <mask> <description> <node id=“0-0-1-1-0”> <header> FOR </header> | Preamble |
| | </node> <node id=“0-0-1-2-0”> <header> FOR </header> </node> <node | annotation |
| | id=“0-0-1-1-1”> <header> CHANGE IS </header> </node> <node id=“0-0-1- | added. |
| | 2-1”> <header> CHANGE IS </header> </node> <node id=“0-0-1-3-1” | |
| | remove> </node> </description> <selection> <node id=“0-0-1”> </node> | |
| | </selection> </mask> | |
| 6 | <mask> <description> <node id=“0-0-1-1-0”> <header> FOR </header> | Preamble |
| | </node> <node id=“0-0-1-2-0”> <header> FOR </header> </node> <node | and |
| | id=“0-0-1-1-1”> <header> CHANGE IS </header> </node> <node id=“0-0-1- | postamble |
| | 2-1”> <header> CHANGE IS </header> </node> <node id=“0-0-1-1-2”> | annotations |
| | <header> AT </header> <tail> POINTS </tail> </node> <node id=“0-0-1-2- | added. |
| | 2”> <header> AT </header> <tail> POINTS </tail> </node> <node id=“0-0-1- | |
| | 3-1” remove> </node> </description> <selection> <node id=“0-0-1”> </node> | |
| | </selection> </mask> | |
| 7 | <mask> <description> <node id=“0-0-1-1-0” keymasks= “MARKETS: <-<-<- | Adds |
| | 1-0 SNAPSHOT: <-<-<-1-0”> <header> FOR </header> </node> <node | keymasks. |
| | id=“0-0-1-2-0” keymasks= “MARKETS: <-<-<-2-0 SNAPSHOT: <-<-<-2-0”> | |
| | <header> FOR </header> </node> <node id=“0-0-1-1-1” keymasks= | |
| | “MARKETS: <-<-<-1-1 SNAPSHOT: <-<-<-1-1”> <header> CHANGE IS | |
| | </header> </node> <node id=“0-0-1-2-1” keymasks=“MARKETS: <-<-<-2-1 | |
| | SNAPSHOT: <-<-<-2-1”> <header> CHANGE IS </header> </node> <node | |
| | id=“0-0-1-1-2” keymasks=“MARKETS: <-<-<-1-2 SNAPSHOT: <-<-<-1-2”> | |
| | <header> AT </header> <tail> POINTS </tail> </node> <node id=“0-0-1-2-2” | |
| | keymasks=“MARKETS: <-<-<-2-2 SNAPSHOT: <-<-<-2-2”> <header> AT | |
| | </header> <tail> POINTS </tail> </node> <node id=“0-0-1-3-1” keymasks= | |
| | “MARKETS: <-<-<-3-1 SNAPSHOT: <-<-<-3-1” remove> </node> | |
| | </description> <selection> <node id=“0-0-1” keymasks=“MARKETS: <-<-< | |
| | SNAPSHOT: <-<-<”> </node> </selection> </mask> | |
| 8 | <mask> <description> <node id=“0-0-1-1-0” keymasks=“MARKETS: <-<-<- | Adds |
| | 1-0 SNAPSHOT: <-<-<-1-0” sp= “(27,29)”> <header> FOR </header> | skeleton |
| | </node> <node id=“0-0-1-2-0” keymasks=“MARKETS: <-<-<-2-0 | and |
| | SNAPSHOT: <-<-<-2-0” sp= “(38,40)”> <header> FOR </header> </node> | references. |
| | <node id=“0-0-1-1-1” keymasks=“MARKETS: <-<-<-1-1 SNAPSHOT: <-<- | |
| | <-1-1”sp= “(30,32)”> <header> CHANGE IS </header> </node> <node | |
| | id=“0-0-1-2-1” keymasks= “MARKETS: <-<-<-2-1 SNAPSHOT: <-<-<-2-1” | |
| | sp=“(41,43)”> <header> CHANGE IS </header> </node> <node id=“0-0-1-1- | |
| | 2” keymasks=“MARKETS: <-<-<-1-2 SNAPSHOT: <-<-<-1-2” sp=“(33,35)” | |
| | > <header> AT </header> <tail> POINTS </tail> </node> <node id=“0-0-1-2- | |
| | 2” keymasks=“MARKETS: <-<-<-2-2 SNAPSHOT: <-<-<-2-2” sp=“(44,46)” | |
| | > <header> AT </header> <tail> POINTS </tail> </node> <node id=“0-0-1-3- | |
| | 1” keymasks=“MARKETS: <-<-<-3-1 SNAPSHOT: <-<-<-3-1” remove | |
| | sp=“(52,54)”> </node> </description> <selection> <node id=“0-0-1” | |
| | keymasks=“MARKETS: <-<-< SNAPSHOT: <-<-<”sp= “(20,64)”> </node> | |
| | </selection> <sklt> HPTRD%dD%dD_drRD_drt | |
| | TRD%drRD%dD#dD#drRD%dD#dD#drRD%dD%drRD%dD%drtPh </sklt> | |
| | <mask> | |

As a result of the above command sequence, only table 952 will appear in the derivative content when primary content similar to model content of panel 904 is transcoded. Table 952 will be presented with rows 1082 and 1084 revised for a more understandable-audio recitation. For example, The recitation based on FIG. 10A may include: “Markets Snapshot. For Dow, change is minus forty nine and sixty four hundredths at eleven thousand one hundred sixty nine and fifty hundredths points. For ‘naz-dack’, change is minus one hundred one and forty hundredths at five thousand forty two and one hundredth points.” The pronunciation of NASDAQ may be specified in a dictionary as described above.

When a set of pages has been or will be prepared on demand to present via an audio user interface or a limited display user interface, transcoder 218 may include additional links to each page. For example, FIG. 10B depicts the display of a limited display device showing derivative content formed in accordance with guidance as discussed above with reference to FIGS. 9 and 10A; and, from primary content from a different date than the model content. Display 1090 includes content 1091, auxiliary links 1092, and switch link 1094. Auxiliary links 1092 provide access to other pages (for news content, weather content, and sports content) derived from the same primary content (e.g., by summarization as discussed above, or by user definition of guidance for each auxiliary page). In addition, following link 1094 may facilitate transfer of session control as described below with reference to FIG. 11. In an audio presentation, auxiliary links may include recited control functions such as a menu of items discussed above with reference to Table 2.

The limited display of FIG. 10B provides about 6 lines each with a line length of about 45 characters. If the display provided a line length of less than 45 characters, the lines as shown may be wrapped onto additional lines. The limited display device may have a buffer for retaining more lines than fit on the display screen and provide user operated scrolling controls to effectively move different portions of the buffer onto the display for presentation.

Predetermined guidance may be applied to primary content to produce derivative content. As discussed above, model content may be used to develop the predetermined guidance. Predetermined guidance may include a description of the model content, for example, a skeletal description in the MASK markup language. In addition, a description of any primary content may be prepared and used: (a) to identify whether particular predetermined guidance that has been associated with similar model content is to be used with the primary content; and (b) to prepare the derivative content. The first use may be accomplished by comparing the description of the primary content with a description of the model content. The second use may be accomplished by aligning the description of the model content to the description of the primary content.

For example, in method 304 of FIG. 4, preparation of derivative content may be performed by transcoder proxy server 125 as part of transcode process 218. To prepare derivative content based on primary content, according to various aspects of the present invention, a skeletal description of suitable model content is located, for example, with reference to a URL of the primary content and a URL that includes a regular expression as discussed above.

After the primary content has been received, a skeletal description of the primary content may be generated. For example, primary content somewhat similar to model content schematically presented in panel 906 of FIG. 9 is presented in HTML in Table 9. Typical primary content is of considerably greater quantity and complexity. Note that panel 906 may be prepared for readability by, inter alia, redacting the actual news stories, inserting table lines, and adding check boxes for selecting various features for convenience of preparing guidance.

TABLE 9
Primary Content in Markup Language

<html> <body>
<table border>

<tr> <td colspan=1> <b>HEADLINE STORY: Authorities in several countries have expressed

interest in adopting a world-wide uniform monetary system. The United States has not yet taken a
supportive role, though delegates from the Federal Reserve Board are attending. Informed sources
say a strictly metric quantification (1-10-100) is suggested to replace the 1-5-10-20-50-100 system
used in the United States. </b> </td>

<td colspan=1> <b>TECHNOLOGY: Powerful lasers have been aimed at the moon in an

experimental communication system hoped to replace broadcast and satellite television, according
to researchers at the Lunar Labs Consortium. Proponents say the system will provide a hierarchical
organization of television entertainment with links between shows to similar shows and related
work by the same actors and actresses.</b> </td>

<td colspan=1> <a href=freeaccess.html> FREE INTERNET ACCESS </a> </td> </tr>
<tr> <td colspan=3> <form action=search.pl> <input type=text name=search>
<input type=submit name=submit value=search> <a href=advanced_search.pl>
ADVANCED SEARCH</a > </form> </td> </tr> </table>

<table border>

<tr> <td colspan=3 align=center> <b>MARKETS SNAPSHOT</b> </td> </tr>
<tr> <td colspan=1>DOW</td> <td colspan=1>−49.64</td>

<td colspan=1>11169.50</td> </tr>

<tr> <td colspan=1>NASDAQ</td> <td colspan=1>−101.40</td>

<td colspan=1>5042.01</td> </tr>

<tr> <td colspan=1>LAST UPDATE AT 03/24 12:23pm</td>

<td colspan=1>SPONSORED BY XTRADE</td> </tr>

<tr> <td colspan=1> <form action=stockquotes.pl> <input type=text name=quote>

<input type=submit name=q value=QUOTE> </form> </td>
<td colspan=1>TRACK WITH NEWSCORP</td> </tr>

</table> </body> </html>

Using the MASK markup language, a description of the primary content of Table 9 is presented in Table 10. White space has been added to clarify the comparison and generally would not appear in the skeletal descriptions.

TABLE 10
Description of Primary Content

<sklt>
HB
TRD$dD$dD_%dr

RDFII_%fdr

TRD%dr

RD%dD#dD#dr
RD%dD#dD#dr
RD%dD%dr
RDFII%fdD%drt

bh
</sklt>

The MASK markup language identifies non-structural elements (e.g., table cell contents, text, numbers, links, graphics, etc.) with reference to numbered nodes of the primary content (and similarly for the model content). Numbered nodes do not appear explicitly in the markup language of the primary content, but they are apparent from analysis of the nesting level of the tags used for the content. A pair of tags enclosing content denotes a node of the tree. The root and all nodes at the same level are numbered from zero, left-to-right. Examples of nodes are illustrated in Table 11.

TABLE 11

| Content | Node Identification |
|---|---|
| <html> | 0 |
| <body> Contributors | 0-0 |
| <table> | 0-0-0 |
| <tr> | 0-0-0-0 |
| <td> Abel </td> | 0-0-0-0-0 |
| <td> Baker </td></tr> <tr> | 0-0-0-0-1 |
| <td> Cook </td> | 0-0-0-1-0 |
| <td> Dickson </td> </tr> </table> | 0-0-0-1-1 |
| <table> | 0-0-1 |
| <tr> | 0-0-1-0 |
| <td> Egan </td> | 0-0-1-0-0 |
| <td> Fromme </td> </tr> <tr> | 0-0-1-0-1 |
| <td> Gable </td> | 0-0-1-0-2 |
| <td> Harris </td> </tr> </table> </body> </html> | |

Using the node numbering as in Table 11, the non-structural content “Dickson” could be copied to the derivative content with reference to its node number “0-0-0-1-1”. Because the node numbering of primary content is subject to change (e.g., a new table is added to the body) content to be copied to the derivative content may be identified with reference to other structural and non-structural features of the primary content. In the model content shown in FIG. 10A, for example, the word “DOW” may be used (instead of the words MARKETS SNAPSHOT) to locate the row 982, 1082 in which the numeric value of the Dow Jones Industrial Average is likely to be found. Using references relative to row 982, node names for other rows and for the entire table 952 may be determined in the model content for use with primary content (e.g., by process 428). Node names with relative references may be more likely to align to future (e.g., different) primary content.

According to various aspects of the present invention, reference to content to be copied to derivative content is made with reference to one or more anchors. An anchor may be located by aligning some or all of a skeletal description as discussed above, or by aligning any one or more elements (e.g., a text string “DOW”, a passage of an expected number of words, a number of links, a link having an expected number of words, etc., as facilitated by parameters of the node guidance tag of Table 4).

Table 8 step 8 provides an example of guidance that includes model content as discussed above with reference to an edit session and FIG. 10A. Note that each anchor is identified by a specification between <node></node> tags. In this example, multiple keymasks are defined in addition to a node number and skeletal position. Transcode process 218 locates the desired content for inclusion in derivative content in accordance with any one or more of the anchor specifications.

Derivative content may be prepared for presentation by a browse process of a workstation 111 (see Table 12), for presentation using an audio user interface and an audio device 202 (see Table 13), or for presentation using a limited display device user interface and a limited display device 702 (see Table 14). Derivative content shown in Tables 11-13 was prepared using primary content of Table 8 and guidance of Table 8 step 8 and therefore includes only the features of table 952 of FIG. 10A. For example, cell 980 is omitted.

TABLE 12
Derivative Content for a Workstation GUI

<html> <table border>
<tr> <td colspan=“3” align=“center”> <b> MARKETS SNAPSHOT </b> </td> </tr>
<tr> <td colspan=“1”> FOR DOW </td> <td colspan=“1”> CHANGE IS −49.64 </td>
<td colspan=“1”> AT 11169.50 POINTS </td> </tr>
<tr> <td colspan=“1”> FOR NASDAQ </td> <td colspan=“1”> CHANGE IS −101.40 </td>
<td colspan=“1”> AT 5042.01 POINTS </td> </tr>
<tr> <td colspan=“1”> LAST UPDATED AT 03/24 12:23 PM </td> </tr>
<tr> <td colspan=“1”> <form action=
“/cgi-bin/mask_selection_ie.pl?url=http://defurl/stockquotes.pl” method=“post”>
<input type=“text” name=“quote”> <input type=“submit” name=“q” value=“QUOTE”>
</form> </td>
<td colspan=“1”> TRACK WITH NEWSCORP </td> </tr>
</table> </html>

Male and female voices are used in the audio user interface to indicate the difference between information and a link. A link may be announced in a female voice. When the link is followed, the announcement of the content may restate the same words for orienting the user; however, the restatement may be in a male voice. For example, when “form 1” is first encountered as a link, a female voice announces it. When a user says “form 1” to follow the link, a male voice may acknowledge that the link was followed and may announce “form 1” as a title before reciting the content of form 1.

TABLE 13
Derivative Content for Audio User Interface

<?xml version=“1.0”?> <vxml version=“1.0”> <form> <block> <prompt>
<pros pitch=“male”> MARKETS SNAPSHOT </pros>
<pros pitch=“male”> for </pros>
<pros pitch=“male”> DOW </pros>
<pros pitch=“male”> change is </pros>
<pros pitch=“male”> −49.64 </pros>
<pros pitch=“male”> at </pros>
<pros pitch=“male”> 11169.50 </pros>
<pros pitch=“male”> points </pros>
<pros pitch=“male”> for </pros>
<pros pitch=“male”> NASDAQ </pros>
<pros pitch=“male”> change is </pros>
<pros pitch=“male”> −101.40 </pros>
<pros pitch=“male”> at </pros>
<pros pitch=“male”> 5042.01 </pros>
<pros pitch=“male”> points </pros>
<pros pitch=“male”> last updated at 03/24 12:23pm </pros>
<pros pitch=“female”> form 1 </pros>
<pros pitch=“male”> TRACK WITH NEWSCORP </pros>
</prompt> </block>
<link next=“#form_1”>
<grammar type=“application/x-jsgf”> form 1 </grammar> </link> </form>
<form id=“form_1”> <block> <prompt>
<pros pitch=“male”> form 1 </pros> </prompt> </block>
<field name=“quote”> </field>
<block>
<submit next=“/cgi-bin/mask_selection_ie.pl?url=http://defurl/stockquotes.pl”/>
</block> </form> </vxml>

TABLE 14
Derivative Content for Limited Display User Interface

<?xml version=“1.0”?>
<!DOCTYPE wml PUBLIC “-//PHONE.COM//DTD WML 1.1//EN”
“http://www.phone.com//dtd/wml11.dtd”>
<wml> <head>
<meta http-equiv=“Cache-Control” content=“max-age=60” forua=“true”/>
</head>
<card id=“none”>
<onevent type=“onenterforward”>
<refresh>
<setvar name=“defurlroot” value=“/cgi-bin/mask_selection_ie.pl?url=”/>
</refresh>
</onevent>
<p> <table columns=“3”>
<tr> <td> <b> MARKETS SNAPSHOT </b> </td> </tr>
<tr> <td> for DOW </td> <td> change is −49.64 </td> <td> at 11169.50 points </td> </tr>
<tr> <td> for NASDAQ </td><td>change is −101.40</td><td>at 5042.01 points </td> </tr>
<tr> <td> last updated at 03/24 12:23pm</td> </tr>
<tr> <td> TRACK WITH NEWSCORP </td> </tr>
</table> </p>
<do type=“accept” label=“form0”>
<go href=“#form0”> </go> </do> </card>
<card id=“form0”>
<do type=“accept” label=“submit”>
<go href=“$(defurlroot:noesc)http://defurl/stockquotes.pl” method=“post”>
<postfield name=“quote” value=“$quote”/> </go> </do>
<p> <input type=“text” name=“quote”/> </p> </card> </wml>

According to various aspects of the present invention, a user having more than one access device (or a device suitable for use with more than one user interface) may from time to time use two or more access devices (or user interfaces) in series or in parallel. The user may provide input via any of the user interfaces discussed above (e.g., workstation GUI, audio user interface, or limited display user interface) and effect system operation with one or more of these interfaces from that point forward. For example, a user may begin a session accessing the Internet via a wireless device 112 or 702 and a limited display device user interface, indicate to the browse process 708 that the session is to continue in audio, and possibly indicate to the audio user interface (e.g., voice browser 216 as discussed above) that the session is to resume on the limited display device. In an alternate implementation, session switching may include control from time to time by a workstation 111 GUI 832.

During a transfer of control, one or more of these access devices or user interfaces may have exclusive control of the session, or may have nonexclusive control (e.g., an input on any user interface is treated as an input for browsing and an output is provided in parallel on all access devices). Output may be provided exclusively to the interface being used in an exclusive manner, or may be provided as indicated by the user on two or more interfaces.

For example, message sequence 1100 of FIG. 11 may be used to facilitate transfer of session control exclusively from a limited display device user interface to an audio user interface and back to the limited display device user interface. In this sequence, one operator uses a web phone 1102 comprising an audio access device 202, a limited display device 702, and processing capability to support browse process 1105, call process 1108, and I/O process 206 (to the extent not implemented in circuitry). Web phone 1102 is initially linked as a wireless device 112 of FIG. 1 to Internet 130 by link 171, wireless gateway 121, link 172, ISP server 124, and link 179. In an alternate implementation, web phone 1102 may be linked as a wireless device 112 to Internet 130 by link 171, wireless gateway 121, link 174, transcoder proxy server 125, and link 178. Web phone is shown already participating in a session with audio/LDD browse process 1106 on browser server 1104. Browser server 1104 in alternate implementations includes the functions described above with reference to voice browser server 123 and/or browser server 704. An audio/LDD browse process 1106 supports both an audio user interface and a limited display device (LDD) user interface as discussed above.

Browse process 1105 responds to user inputs (e.g., arrow keys or pen-based events). The user may navigate the Internet in the conventional manner selecting links using user inputs. At any time, the user may desire to continue the session via an audio user interface. To do so, the user may follow a link (step 1120) provided on the limited display device by audio/LDD browse process 1106 (e.g., link 1094 of FIG. 10B for the current content in audio, or link 1096 of FIG. 10B for an Internet radio site). The link may include a URL corresponding to a TO_AUDIO command. Alternately, limited display device may have circuitry, software, or accept user inputs to provide a command TO_AUDIO to audio/LDD browse process 1106. The command may conform to a URL, e.g., the URL of browser server 1104. Browse process 1106 may respond to the TO_AUDIO command by obtaining information from web phone 1102 sufficient to confirm authorization for the audio session and configuration information for establishing a proper audio connection. Such information may be available via one or more cookies or URL parameters from web phone 1102 or from registration data obtained by browse process 1106 when the initial user session with browse process 1106 began. A login scenario, as discussed above, may also be conducted by browse process 1106. When the TO_AUDIO command is a URL, a parameter of the URL may identify a particular page to be delivered in audio (e.g., the same information as on the current page, another page based on the same primary content, an Internet radio site, a listing of predetermined audio sites, etc.). An identifier of the particular page (e.g., URL9) may be stored (step 1121) in association with user information 1110 (e.g., a usemame, caller ID, origination phone number, or registration information).

After confirmation that the switch to an audio user interface is authorized and proper, browse process 1106 may notify the user with a suitable acknowledgement (step 1122). The acknowledgement may include a link and a phone number to call to establish an audio session. In one implementation, the phone number is part of the link in the WML markup language (e.g., <a href=“wtai://wp/mc; 1aaaeeennnnn”>TO AUDIO </a> where wtai is a scheme of the type known as Wireless Telephony Application Interface; “wp/mc” specifies a library of WTAPublic and a command “mc” to make a call; and “aaaeeennnn” would be a 10-digit US telephone number).

The user may follow the link (step 1123) which effects a telephone call (step 1124) from web phone 1102 (and call process 1108) to browser server 1104 (and browse process 1106). For example, browse process 1106 may send an applet to browse process 1105 with the acknowledgement (step 1122). Browse process 1105 may then initiate a phone call from web phone 1102 to browser server 1104 and may provide a user identification (step 1125). Browse process 1106 may use conventional caller ID technology to authenticate the user (step 1125).

In an alternate implementation, command TO_AUDIO causes browse process 1105 to prepare for an incoming telephone call, and audio/LDD browse process 1106 (having sufficient authorization to proceed) to effect a telephone call to web phone 1102.

Regardless of whether browse process 1106 or browse process 1105 initiates the phone call, web phone 1102 is eventually connected as cell phone 114 of FIG. 1 via link 175, cellular gateway 122, and link 176 through voice browser server 123 acting as browser server 1104. Voice browser server 123 is coupled to the Internet 130 via link 177, transcoder proxy server 125, and link 178.

As indicated by the user in the TO_AUDIO command or in any conventional manner, the recitation in audio of an appropriate initial page is provided from audio/LDD browse process 1106 to I/O process 206 performed by audio device 202. For example, the user of limited display device 702 may have supplied URL9 as stored with user information 1110. Audio/LDD browse process 1106 may use the caller ID or other user information to recall an identification of desired content URL9 (step 1126). Browse process 1106 may transcode primary content of URL9 as discussed above or obtain streaming audio content from Internet 130 and pass it to I/O process 206 as RECITAL9 (step 1127). User of limited display device 702 may desire to listen to primary content transcoded in accordance with guidance as discussed above. Browse process 1106 in this case provides functions of voice browser server 123 (e.g., voice recognition for navigation commands) and cooperates with transcoder proxy server 125.

The user may at any time direct I/O process 206 to convey a command (TO_LDD) to browse process 1106 (step 1128) for continuing the session on limited display device 702. The command may include DTMF signaling or the user's voice command, for example, “Send Me the Page” or another suitable command as in Table 2. Browse process 1106 responds (step 1130) with suitable derivative content (PAGE10), for example, as discussed above with reference to step 780. The TO_LDD command may be recognized by speech recognition software that provides notice in any conventional manner to other processes of browse process 1106 to switch from an audio user interface to a limited display device user interface.

While for the sake of clarity and ease of description, several specific embodiments of the invention have been described; the scope of the invention is intended to be measured by the claims as set forth below. The description is not intended to be exhaustive or to limit the invention to the form disclosed. Other implementations of the invention will be apparent in light of the disclosure and practice of the invention to one of ordinary skill in the art to which the invention applies.

What is claimed is:

1. A method for transcoding information provided in a first markup language, the method comprising:
selecting a portion of the information;
determining a complexity of the selected portion;
preparing, if the complexity of the selected portion exceeds a limit, a hypertext link and a subset of the information, the hypertext link for accessing the subset of the information;
providing at least one of the selected portion, the hypertext link, and the subset; and providing an annotation associated therewith.

2. The method of claim 1 wherein the step of determining the complexity comprises:
calculating a statistic of the portion, the statistic in accordance with at least one of number of bytes, number of words, number of tables, number of hypertext links, and number of words in hypertext links; and
determining the complexity in accordance with whether the statistic exceeds a limit.

3. The method of claim 1 wherein:
the method further comprises repeating the steps of selecting, determining, and preparing for a plurality of portions of the information; and
the prepared hypertext links are provided in a list.

4. The method of claim 3 wherein:
the step of determining further comprises determining an importance of the selected portion; and
the hypertext links are provided in the list in accordance with the respective importance of each selected portion.

5. The method of claim 3 wherein the step of repeating is performed for a portion of the information that is accessible via a particular prepared hypertext link after user navigation of the particular hypertext link via the list.

6. A server for voice browsing and transcoding, the server comprising indicia of the method of claim 1.

7. The method of claim 1 wherein the step of providing is performed via the Internet.

8. A method for developing guidance for a transcoding process, the method comprising:
receiving information in accordance with a first markup language;
presenting a plurality of portions of the received information;
associating an annotation with a selected portion; and
storing the association, the annotation, and the selected portion in accordance with a second markup language, the first markup language and the second markup language each having at least one pair of tags unique to the respective language.

9. The method of claim 8 wherein:
the selected portion is enclosed in a first pair of tags;
the annotation is enclosed in a second pair of tags; and
the first pair of tags further enclose the second pair of tags.

10. The method of claim 8 wherein the first markup language complies with the Extended Markup Language specification; and the second markup language complies with the Extended Markup Language specification.

11. The method of claim 8, wherein:
the method further comprises receiving a Uniform Resource Locator comprising indicia of a desired association between the annotation and the selected portion; and
the step of associating is performed in accordance with the indicia.

12. The method of claim 8, wherein:
the method further comprises receiving a Hyper-Text Transport Protocol POST command comprising indicia of a desired association between the annotation and the selected portion; and
the step of associating is performed in accordance with the indicia.

13. A method for transcoding information provided in a first markup language and associated with a first Uniform Resource Locator, the method comprising:
obtaining guidance in accordance with at least a portion of the first Uniform Resource Locator, the guidance comprising a first description and an annotation;
preparing a second description of at least a first portion of the information;
determining a correlation between the first description and the second description;
providing, if the correlation exceeds a limit, at least a second portion of the information and the annotation.

14. The method of claim 13 wherein the second description comprises a key word.

15. The method of claim 13 wherein the second description comprises a string of characters and a character of the string corresponds to a tag of the first markup language.
